(19) United States
(12) Patent Application Publication
(10) Pub. No.: US 2016/0263829 A1
(43) Pub. Date: Sep. 15, 2016

(54) THREE-DIMENSIONAL MODELING APPARATUS, MANUFACTURING METHOD, AND COMPUTER PROGRAM

(71) Applicant: SEIKO EPSON CORPORATION, Tokyo (JP)

(72) Inventors: Eiji OKAMOTO, Matsumoto (JP); Shinichi NAKAMURA, Okaya (JP); Koki HIRATA, Shiojiri (JP)

(21) Appl. No.: 15/061,316

(22) Filed: Mar. 4, 2016

(30) Foreign Application Priority Data
Mar. 12, 2015 (JP) 2015-049146

(51) Int. Cl. B29C 67/00

(52) U.S. Cl. CPC B29C 67/0081; B29C 67/0088; B33Y 50/00

(57) ABSTRACT

A technique that makes it possible to improve the accuracy of modeling in a three-dimensional modeling apparatus for modeling a three-dimensional object by discharging a liquid to a powder composition layer is provided. The three-dimensional modeling apparatus includes a powder composition layer forming unit for forming a powder composition layer using a powder-containing composition containing powder; a head unit from which a curable liquid is discharged to a first surface of the powder composition layer; and a curing energy applying unit for applying curing energy to the liquid at a time that is after the liquid is discharged from the head unit, before the liquid permeates the powder composition layer and reaches a second surface of the powder composition layer, and at which at least a portion of the liquid exists on the head unit side with respect to the first surface of the powder composition layer.

### BACKGROUND

1. Technical Field

The present invention relates to a three-dimensional modeling apparatus.

2. Related Art

In recent years, three-dimensional modeling apparatuses employing an inkjet technique have been attracting attention. With this type of three-dimensional modeling apparatus, a three-dimensional object is modeled by performing, over a number of layers in the height direction, a step of forming a cross section body by discharging a curable liquid from an inkjet head to a powder composition layer (see JP-A-06-218712 and JP-A-2001-150556, for example).

### SUMMARY

The liquid discharged from the inkjet head lands on the powder composition layer and permeates the powder composition layer in every direction. Therefore, with the technique in the related art, there are cases where the liquid wets the powder composition layer and spreads outward, whereby the outline of the modeled object is blurred. Accordingly, there is demand for a technique that makes it possible to improve the accuracy of modeling in a three-dimensional modeling apparatus for modeling a three-dimensional object by discharging a liquid to a powder composition layer.

An advantage of some aspects of the invention is to solve at least some of the foregoing problems, and the invention can be achieved as the following aspects.

(1) According to one aspect of the invention, a three-dimensional modeling apparatus for modeling a three-dimensional object is provided. This three-dimensional modeling apparatus includes a powder composition layer forming unit for forming a powder composition layer using a powder-containing composition that contains powder; a head unit from which a curable liquid is discharged to a first surface of the powder composition layer; and a curing energy applying unit for applying curing energy to the liquid at a time that is after the liquid is discharged from the head unit, before the liquid permeates the powder composition layer and reaches a second surface of the powder composition layer, and at which at least a portion of the liquid exists on the head unit side with respect to the first surface of the powder composition layer. With this aspect of the three-dimensional modeling apparatus, the curing energy is applied to the liquid before the liquid reaches the second surface from the first surface of the powder composition layer and when at least a portion of the liquid exists on the head unit side with respect to the first surface of the powder composition layer, thus making it possible to suppress excessive wet spreading of the liquid in the powder composition layer. Therefore, the three-dimensional object can be modeled more accurately.

(2) In the above aspect of the three-dimensional modeling apparatus, the curing energy applying unit may apply the curing energy such that a curing ratio of the liquid is 20% or more and 50% or less. With this aspect of the three-dimensional modeling apparatus, it is possible to more effectively suppress excessive wet spreading of the liquid in the powder composition layer.

(3) In the above aspect of the three-dimensional modeling apparatus, after the liquid is discharged, the curing energy applying unit may apply the curing energy such that a portion of the liquid that is located on the head unit side with respect to the first surface of the powder composition layer has a fluidity lower than that of a portion that is located on the second surface side with respect to the first surface of the powder composition layer. With this aspect of the three-dimensional modeling apparatus, it is also possible to more effectively suppress excessive wet spreading of the liquid in the powder composition layer.

(4) In the above aspect of the three-dimensional modeling apparatus, the curing energy applying unit may start to apply the curing energy before a diameter of the liquid discharged from the head unit along the first surface reaches a value obtained by adding a value of twice a thickness of the powder composition layer to a diameter of the liquid when the liquid lands on the powder composition layer. With this aspect of the three-dimensional modeling apparatus, it is possible to apply the curing energy before the liquid finishes spreading in the powder composition layer, thus making it possible to suppress excessive wet spreading of the liquid in the powder composition layer.

(5) In the above aspect of the three-dimensional modeling apparatus, the curing energy applying unit may start to apply the curing energy 30 milliseconds to 1 second after the liquid is discharged from the head unit. With this aspect of the three-dimensional modeling apparatus, it is possible to increase the likelihood of applying the curing energy at a time that is before the liquid reaches the second surface from the first surface of the powder composition layer, and at which at least a portion of the liquid exists on the head unit side with respect to the first surface of the powder composition layer.

(6) In the above aspect of the three-dimensional modeling apparatus, the powder-containing composition may contain powder, a water-soluble resin, and a solvent.

The invention can also be achieved in various aspects other than aspects as a three-dimensional modeling apparatus. For example, the invention can be achieved in aspects such as a method for manufacturing a three-dimensional object using a three-dimensional modeling apparatus, a computer program for causing a computer to control a three-dimensional modeling apparatus to model a three-dimensional object, and a non-transitory tangible recording medium on which the computer program is recorded.

### BRIEF DESCRIPTION OF THE DRAWINGS

The invention will be described with reference to the accompanying drawings, wherein like numbers reference like elements.

FIG. 1 is an explanatory diagram showing a schematic configuration of a three-dimensional modeling apparatus as a first embodiment.

FIGS. 2A to 2D are diagrams showing a state in which a binding material gradually permeates a powder composition layer in the embodiment.

FIG. 3 is a diagram for illustrating the time when provisional curing is performed.

FIG. 4 is a diagram showing a typical composition of a powder composition.

FIG. 5 is a diagram showing a list of experimental results.

FIG. 6 is a diagram showing a relationship between provisional curing energy and a curing ratio.

FIGS. 7A and 7B are diagrams showing a modeled pattern for determining whether or not an outline is blurred.

FIG. 8 is a partially enlarged view of FIG. 7A.

FIG. 9 is a partially enlarged view of FIG. 7B.

### DESCRIPTION OF EXEMPLARY EMBODIMENTS

### A. First Embodiment

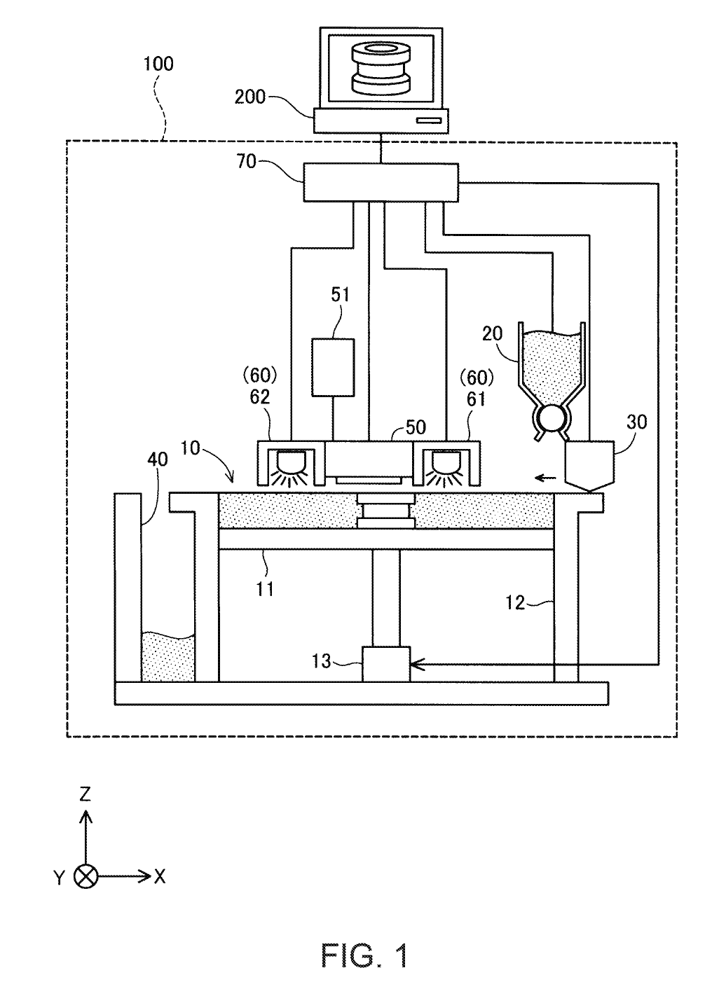

FIG. 1 is an explanatory diagram showing a schematic configuration of a three-dimensional modeling apparatus as a first embodiment of the invention. A three-dimensional modeling includes a modeling unit 10, a powder composition supply unit 20, a flattening mechanism 30, a powder composition collecting unit 40, a head unit 50, a curing energy applying unit 60, and a control unit 70. A computer 200 is connected to the control unit 70. The three-dimensional modeling apparatus 100 and the computer 200 can be collectively regarded as a three-dimensional modeling apparatus in a broad sense. In FIG. 1, an X direction, a Y direction and a Z direction that orthogonally intersect one another are shown. The Z direction is a direction along a vertical direction, and the X direction is a direction along a horizontal direction. The Y direction is a direction orthogonal to the Z direction and the X direction. Hereinafter, the +Z direction side in FIG. 1 is referred to as “upper side”, and the −Z direction side is referred to as “lower side”.

The modeling unit 10 is a tank-shaped structure in which a three-dimensional object is modeled. The modeling unit 10 includes a flat modeling stage 11 that lies in the X and Y directions, a frame body 12 that surrounds the periphery of the modeling stage 11 and is erect in the Z direction, and an actuator 13 that moves the modeling stage 11 in the Z direction. The modeling stage 11 moves in the Z direction in the frame body 12 by the control unit 70 controlling the operations of the actuator 13.

The powder composition supply unit 20 is an apparatus for supplying a powder composition (more specifically, a powder-containing composition that contains powder) into the modeling unit 10. The powder composition supply unit 20 includes a hopper or a dispenser, for example. The composition of the powder composition will be described later.

The flattening mechanism 30 is a mechanism for flattening the powder composition supplied into the modeling unit 10 or on the frame body 12 and forming a powder composition layer on the modeling stage 11 by moving on the upper surface of the modeling unit 10 in the horizontal direction (X and Y directions). The flattening mechanism 30 includes a squeegee or a roller, for example. The powder composition pushed out from the modeling unit 10 by the flattening mechanism 30 is discharged into the powder composition collecting unit 40 provided adjacent to the modeling unit 10. The thickness of the powder composition layer is 50 μm or less, and preferably 25 μm or less, for example. The powder composition supply unit 20 and the flattening mechanism 30 correspond to the “powder composition layer forming unit” in this application.

A tank 51 is connected to the head unit 50. The tank 51 accommodates a liquid (binding agent) for binding the powder particles in the powder composition layer. The liquid is supplied from the tank 51 to the head unit 50, and discharged in the Z direction from the head unit 50 onto the powder composition layer in the modeling unit 10. The head unit 50 can move in the X direction and the Y direction with respect to a three-dimensional object modeled in the modeling unit 10. In addition, the head unit 50 can also move in the Z direction relative to the three-dimensional object by the modeling stage 11 inside the modeling unit 10 moving in the Z direction. Object portion forming ink and sacrificial layer forming ink can be discharged from the head unit 50 as the liquid. The object portion forming ink is ink for forming an object portion of the three-dimensional object. The sacrificial layer forming ink is ink for forming a sacrificial layer that supports an overhanging portion and the like provided in the object portion. In this embodiment, ultraviolet curable ink is used as these types of ink. The sacrificial layer made of the sacrificial layer forming ink is removed after the three-dimensional object is modeled. The specific compositions of the object portion forming ink and the sacrificial layer forming ink will be described later.

The head unit 50 of this embodiment is a so-called piezoelectric drive type droplet discharging head. By filling a pressure chamber having a minute nozzle hole with a liquid and warping the side wall of the pressure chamber using a piezoelectric element, liquid with a volume corresponding to the amount by which the volume of the pressure chamber is reduced can be discharged from the piezoelectric drive type droplet discharging head as droplets. The control unit 70, which will be described later, can adjust the amount of liquid per droplet to be discharged from the head unit 50 by controlling the waveform of a voltage that is applied to the piezoelectric element.

The curing energy applying unit 60 is an apparatus for applying energy for curing the liquid discharged from the head unit 50. In this embodiment, the curing energy applying unit 60 includes a main curing light emitting apparatus 61 and a provisional curing light emitting apparatus 62 that are arranged so as to sandwich the head unit 50 in the X direction. The provisional curing light emitting apparatus 62 is used to perform provisional curing (pinning) for suppressing wet spreading of the liquid discharged from the head unit 50 in the powder composition layer in the lateral direction. The main curing light emitting apparatus 61 is used to perform main curing (curing) for completely curing the liquid after the provisional curing. In this embodiment, the main curing light emitting apparatus 61 and the provisional curing light emitting apparatus 62 emit ultraviolet rays as curing energy for curing the liquid. The curing energy applying unit 60 may also be an apparatus for, depending on the type of the liquid, applying another type of energy as the curing energy. Hereinafter, the energy applied by the provisional curing light emitting apparatus 62 for the provisional curing is referred to as “provisional curing energy”, and the energy applied by the main curing light emitting apparatus 61 for the main curing is referred to as “main curing energy”. In this embodiment, the provisional curing refers to a state in which the liquid is cured so as to have a viscosity with which wet spreading of the liquid in the powder composition layer in the lateral direction can be suppressed, or curing the liquid in such a manner.

The provisional curing light emitting apparatus 62 and the main curing light emitting apparatus 61 apply the provisional curing energy and main curing energy respectively while moving with the movement of the head unit 50. More specifically, when the liquid is discharged from the head unit 50 while the head unit 50 moves in the +X direction, for example, the provisional curing light emitting apparatus 62 applies the provisional curing energy while passing over the discharged liquid. When the head unit 50 reaches the end portion in the +X direction, the head unit 50 returns in the −X direction. At this time, the main curing light emitting apparatus 61 applies the main curing energy while moving in the −X direction over the liquid subjected to the provisional curing. The time when the provisional curing energy or the main curing energy is applied can be determined by adjusting the distance from the head unit 50 to the main curing light emitting apparatus 61 or the provisional curing light emitting apparatus 62 and by adjusting the moving speed of the head unit 50. It should be noted that the main curing light emitting apparatus 61 and the provisional curing light emitting apparatus 62 may be provided independent of the head unit 50.

The control unit 70 includes a CPU and a memory. The CPU has a function of controlling the actuator 13, the powder composition supply unit 20, the flattening mechanism 30, the head unit 50 and the curing energy applying unit 60 to model a three-dimensional object by loading a computer program stored in the memory or a recording medium to the memory and executing the program. This function includes a function of controlling the curing energy applying unit 60 so as to apply the curing energy to the liquid at a time that is after the liquid is discharged from the head unit 50, before the liquid permeates the powder composition layer and reaches the lower surface of the powder composition layer, and at which at least a portion of the liquid exists on the head unit 50 side with respect to the upper surface of the powder composition layer. It should be noted that the functions of the control unit 70 may be realized by an electronic circuit. Moreover, the functions of the control unit 70 may also be included in the computer 200.

A method for modeling (manufacturing) a three-dimensional object using the three-dimensional modeling apparatus 100 will be briefly described. First, the computer 200 slices polygon data indicating the shape of the three-dimensional object in accordance with a modeling resolution (lamination pitch) in the Z direction, and generates a plurality of pieces of cross section data in the X and Y directions. This cross section data has a predetermined modeling resolution in the X direction and the Y direction, and is represented by two-dimensional bitmap data in which gradation values are stored for each element. The gradation values stored for each element represent amounts of liquid to be discharged at XY coordinates corresponding to the elements. That is, in this embodiment, the coordinates at which the liquid is to be discharged and the amounts of liquid to be discharged are designated by the bitmap data for the control unit 70 of the three-dimensional modeling apparatus 100.

Upon acquiring the cross section data from the computer 200, the control unit 70 of the three-dimensional modeling apparatus 100 controls the powder composition supply unit 20 and the flattening mechanism 30 to form a powder composition layer in the modeling unit 10. The control unit 70 then drives the head unit 50 so that the liquid is discharged onto the powder composition layer in accordance with the cross section data, and subsequently controls the curing energy applying unit 60 to emit ultraviolet light toward the discharged liquid and perform the provisional curing and the main curing. The liquid is then cured due to the ultraviolet light, particles in the powder composition bind to one another, and a cross section body corresponding to cross section data for one layer is formed in the modeling unit 10. After the cross section body for one layer is formed in this manner, the control unit 70 drives the actuator 13 so as to lower the modeling stage 11 in the Z direction by the lamination pitch corresponding to the modeling resolution in the Z direction. When the modeling stage 11 is lowered, the control unit 70 forms a new powder composition layer on the cross section body, which has been already formed on the modeling stage 11. When the new powder composition layer is formed, the control unit 70 receives the next piece of cross section data from the computer 200 and forms a new cross section body by discharging the liquid onto the new powder composition layer and emitting ultraviolet light. In this manner, upon receiving cross section data for each layer from the computer 200, the control unit 70 controls the actuator 13, the powder composition supply unit 20, the flattening mechanism 30, the head unit 50, and the curing energy applying unit 60 to form a cross section body for each layer and consecutively laminate the cross section bodies, thereby modeling a three-dimensional object.

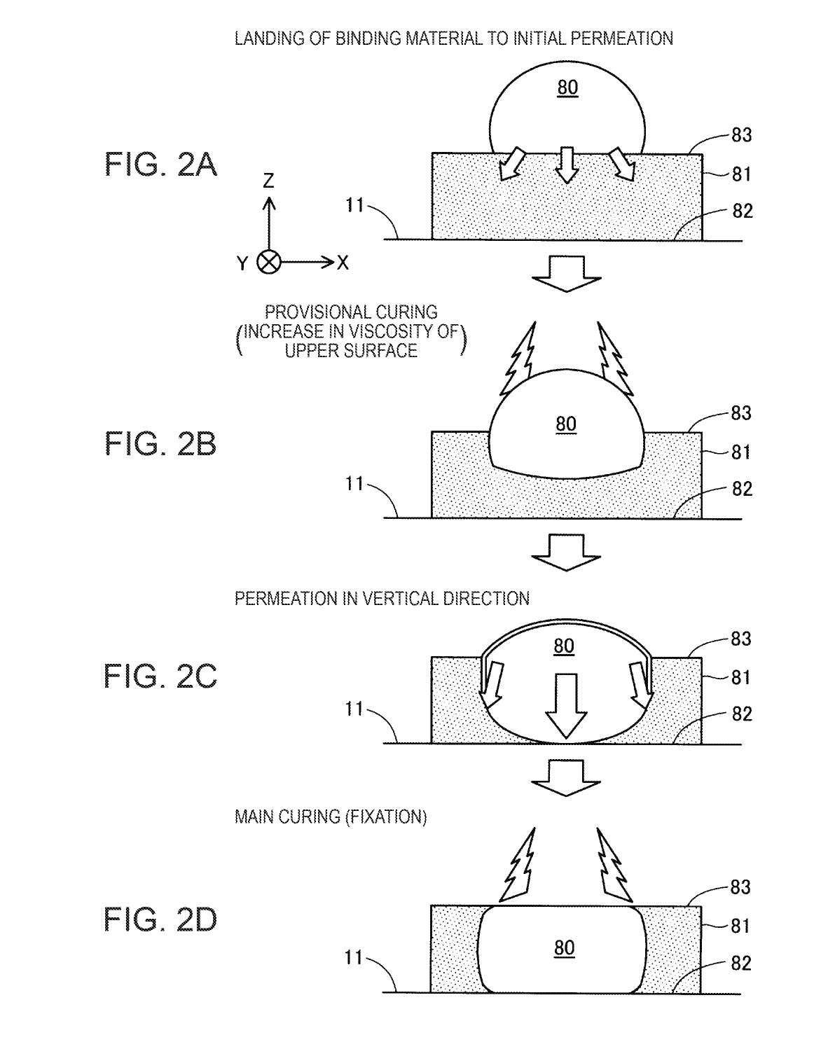

FIGS. 2A to 2D are diagrams showing a state in which the liquid gradually permeates the powder composition layer in this embodiment. In this embodiment, first, as shown in FIG. 2A, when liquid 80 in the form of droplets is discharged from the head unit 50, the liquid lands on the modeling stage 11 or on a powder composition layer 81 formed on a cross section body that was formed previously. The flight speed of the liquid 80 discharged from the head unit 50 is 6 to 10 m/second, for example.

In this embodiment, right after the liquid 80 lands on the powder composition layer 81, the control unit 70 controls the curing energy applying unit 60 to apply the provisional curing energy as shown in FIG. 2B, and the liquid 80 is subjected to the provisional curing. The time when the curing energy applying unit 60 applies the provisional curing energy is a time that is after the liquid 80 is discharged from the head unit 50, before the liquid 80 reaches a bottom surface 82 of the powder composition layer 81, and at which at least a portion of the liquid 80 exists above an upper surface (first surface) 83 of the powder composition layer 81.

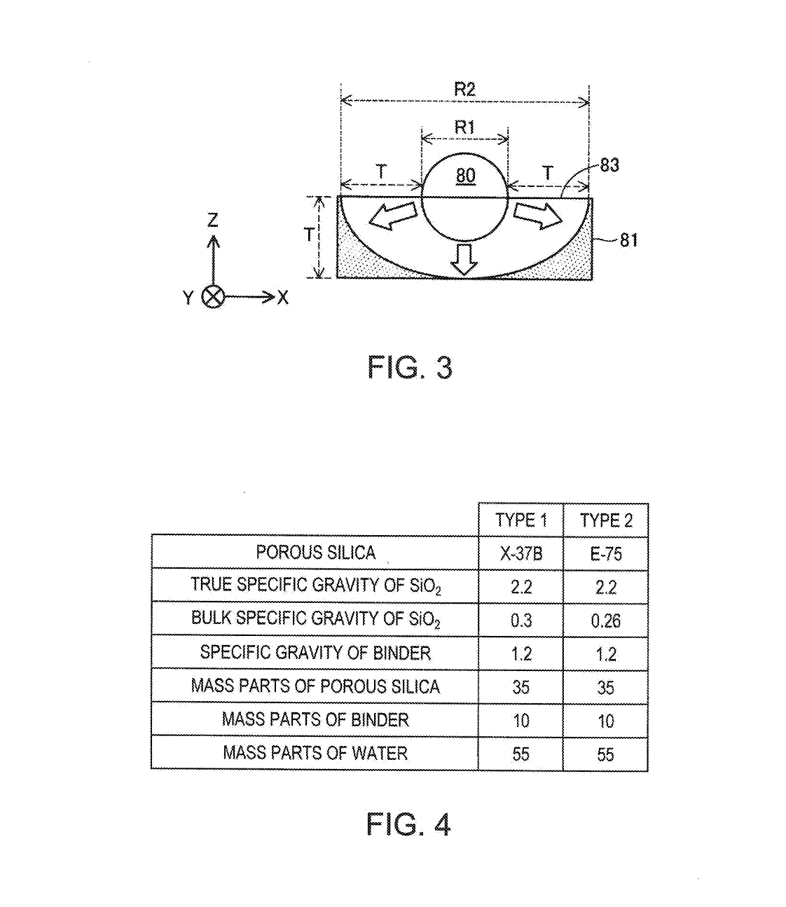

FIG. 3 is a diagram for illustrating the time when the provisional curing is performed. Furthermore, it is preferable that the time when the above provisional curing is performed is before a diameter R2 of the liquid 80 discharged from the head unit 50 in the X and Y directions reaches a value (R1+2T), which is obtained by adding a value of twice a thickness T of the powder composition layer 81 to a diameter R1 of the liquid 80 when the liquid 80 lands on the powder composition layer 81, or more specifically, when the liquid 80 returns to its original shape due to surface tension after being deformed in the lateral direction (X and Y directions) upon landing. This is because there is a possibility that the liquid 80 mainly wets the upper surface 83 of the powder composition layer 81 and spreads to have the diameter R2 having the above value (R1+2T) at most when the liquid 80 isotropically permeates the powder composition layer 81.

Moreover, it is preferable that in order to suppress excessive spreading of the liquid 80, the curing energy applying unit 60 applies the curing energy such that a portion of the liquid 80 that is located on the head unit 50 side with respect to the upper surface 83 of the powder composition layer 81 has a fluidity lower than that of a portion that is located on the bottom surface (second surface) 82 side with respect to the upper surface 83 of the powder composition layer 81. If the provisional curing is performed at a time when a portion of the liquid 80 is located above the upper surface of the powder composition layer 81 and the remaining portion of the liquid 80 is located below the upper surface of the powder composition layer 81, the portion of the liquid 80 located above the upper surface of the powder composition layer 81 will inevitably have a fluidity lower than that of the portion located on the bottom surface 82 side with respect to the upper surface 83 of the powder composition layer 81.

Furthermore, it is preferable that the curing energy applying unit 60 starts to apply the provisional curing energy 30 milliseconds to 1 second after the liquid 80 is discharged from the head unit 50. If the provisional curing energy starts to be applied at such a time, it is possible to increase the likelihood that the provisional curing will be performed at the time that is after the liquid 80 is discharged from the head unit 50, before the liquid 80 reaches the bottom surface 82 of the powder composition layer 81, and at which at least a portion of the liquid 80 exists above the upper surface 83 of the powder composition layer 81.

It should be noted that the curing energy applying unit 60 may apply the provisional curing energy before the liquid discharged from the head unit 50 lands on the powder composition layer 81. That is, the curing energy applying unit 60 may perform the provisional curing while the liquid 80 is flying.

It is preferable that the curing energy applying unit 60 applies the provisional curing energy such that the liquid 80 has a curing ratio of 20% or more and 50% or less, and more preferably 30% or more and 40% or less. This preferable range of the curing ratio is based on experimental results, and the specific contents of experiments will be described later.

When the provisional curing energy is applied to the liquid 80 as described above, the viscosity of mainly the upper surface of the liquid 80 increases. Then, as shown in FIG. 2C, the liquid 80 permeates the powder composition layer 81 in the longitudinal direction (downward in the Z direction) without excessively spreading in the lateral direction (X and Y directions). When the liquid 80 permeates the powder composition layer 81 to the bottom surface 82 thereof, the control unit 70 controls the curing energy applying unit 60 to apply the main curing energy from the main curing light emitting apparatus 61 as shown in FIG. 2D, and fixes the liquid 80 in the powder composition layer 81.

With the three-dimensional modeling apparatus 100 of this embodiment, which has been described above, the provisional curing is performed at the time that is after the liquid 80 is discharged onto the powder composition layer 81 from the head unit 50, before the liquid 80 reaches the bottom surface 82 of the powder composition layer 81, and at which at least a portion of the liquid 80 exists above the upper surface 83 of the powder composition layer 81, thus making it possible to increase the viscosity of the upper surface of the liquid 80 before the liquid 80 completely permeates the powder composition layer 81. Therefore, when the liquid 80 permeates the powder composition layer 81 in the longitudinal direction, excessive wet spreading of the liquid 80 in the lateral direction is suppressed. Accordingly, significant protruding of the liquid 80 in the lateral direction from a predetermined accuracy in accordance with the modeling resolution is suppressed. As a result, it is possible to suppress blurring of the outline portion of the three-dimensional object, thus making it possible to accurately model the three-dimensional object.

Moreover, in this embodiment, the viscosity of the upper surface of the liquid 80 increases due to the provisional curing as mentioned above, and therefore, permeation of the liquid 80 in every direction in the powder composition layer 81 is suppressed. As a result, if a state of powder diffusing in the powder composition layer 81 is not uniform, for example, permeation of the liquid 80 in irregular directions is suppressed. Therefore, the modeling accuracy of the three-dimensional object increases, and the feel of the surface of the object can be improved, for example.

Furthermore, with this embodiment, wet spreading of the liquid 80 in the lateral direction is suppressed, thus making it possible to improve the adhesion between the cross section bodies in the vertical direction. This effect is particularly effective in modeling in a mode (e.g., “rapid modeling mode”) in which the cross section bodies each have a thickness of about 100 to 200 μm.

Although the liquid 80 tends to spread in a fan shape in the powder composition layer 81 in the permeation direction as shown in FIG. 3, wet spreading of the liquid 80 in the lateral direction is suppressed in this embodiment, and therefore, spreading of the liquid 80 in a fan shape is also suppressed. As a result, it is possible to suppress the generation of steps on the lateral surface of the modeled object caused by fan-shaped objects being laminated.

### B. Composition of Object Portion Forming Ink and Sacrificial Layer Forming Ink

B1. Object Portion Forming Ink

Curable Resin

The object portion forming ink contains at least a curable resin (curable component). Examples of the curable resin (curable component) include a heat curable resin; various light curable resins such as a visible-light curable resin (light curable resin in a narrow sense) that is cured by light in a visible light region, an ultraviolet ray curable resin, and an infrared ray curable resin; and an X-ray curable resin. These curable resins can be used alone or in combination of two or more. Of these, the ultraviolet ray curable resin (polymerizable compound) is particularly preferable from the viewpoint of the mechanical strength of an obtained three-dimensional object, the productivity of the three-dimensional object, the storage stability of the object portion forming ink, and the like.

Resins in which addition polymerization or ring-opening polymerization is started by radical species, cation species, or the like formed from a photopolymerization initiator by the irradiation of ultraviolet rays to form a polymer are preferably used as the ultraviolet ray curable resin (polymerizable compound). Examples of types of the addition polymerization include radical polymerization, cation polymerization, anion polymerization, metathesis polymerization, and coordinated polymerization. Examples of types of the ring-opening polymerization include cation polymerization, anion polymerization, radical polymerization, metathesis polymerization, and coordinated polymerization.

Examples of addition polymerizable compounds include compounds having at least one ethylenically unsaturated double bond. Compounds having at least one terminal ethylenically unsaturated bond, and preferably two or more terminal ethylenically unsaturated bonds can be preferably used as the addition polymerizable compound. The ethylenically unsaturated polymerizable compound has a chemical form of a monofunctional polymerizable compound, a polyfunctional polymerizable compound, or a mixture thereof.

Examples of the monofunctional polymerizable compound include unsaturated carboxylic acids (e.g., acrylic acid, methacrylic acid, itaconic acid, crotonic acid, isocrotonic acid, and maleic acid), or esters thereof and amides thereof. Examples of the polyfunctional polymerizable compound include esters between unsaturated carboxylic acid and an aliphatic polyhydric alcoholic compound, and amides between unsaturated carboxylic acid and an aliphatic amine compound.

Moreover, addition reaction products between an unsaturated carboxylic acid ester or amide having a nucleophilic substituent such as a hydroxyl group, amino group, or a mercapto group and an isocyanate or an epoxy, dehydration condensation reaction products between such an ester or amide and a carboxylic acid, and the like can also be used. Furthermore, addition reaction products between an unsaturated carboxylic acid ester or amide having an electrophilic substituent such as an isocyanate group or an epoxy group and an alcohol, amine, or thiol, and substitution reaction products between an unsaturated carboxylic acid ester or amide having an eliminatable substituent such as a halogen group or a tosyloxy group and an alcohol, amine or thiol can also be used. As a specific example of a radical polymerizable compound that is an ester between an unsaturated carboxylic acid and an aliphatic polyhydric alcoholic compound, a (meth)acrylate ester is typical, for example, and both a monofunctional (meth)acrylic acid ester and a polyfunctional (meth)acrylic acid ester can be used.

Specific examples of a monofunctional (meth)acrylate include tolyloxyethyl (meth)acrylate, phenyloxyethyl (meth)acrylate, cyclohexyl (meth)acrylate, ethyl (meth)acrylate, methyl (meth)acrylate, isobornyl (meth)acrylate, dipropylene glycol di(meth)acrylate, tetrahydrofurfuryl (meth)acrylate, ethoxyethoxyethyl (meth)acrylate, 2-(2-vinyloxyethoxy)ethyl (meth)acrylate, 2-hydroxy-3-phenoxypropyl (meth)acrylate, and 4-hydroxybutyl (meth)acrylate.

Specific examples of a difunctional (meth)acrylate include ethylene glycol di(meth)acrylate, triethylene glycol di(meth)acrylate, 1,3-butanediol di(meth)acrylate, tetramethylene glycol di(meth)acrylate, propylene glycol di(meth)acrylate, neopentyl glycol di(meth)acrylate, hexanediol di(meth)acrylate, 1,4-cyclohexanediol di(meth)acrylate, tetraethylene glycol di(meth)acrylate, pentaerythritol di(meth)acrylate, and dipentaerythritol di(meth)acrylate.

Specific examples of a trifunctional (meth)acrylate include trimethylolpropane tri(meth)acrylate, trimethylolethane tri(meth)acrylate, trimethylolpropane alkylene oxide modified tri(meth)acrylate, pentaerythritol tri(meth)acrylate, dipentaerythritol tri(meth)acrylate, trimethylolpropane tri((meth)acryloyloxypropyl) ether, isocyanurate alkylene oxide modified tri(meth)acrylate, dipentaerythritol propionate tri(meth)acrylate, tri((meth)acryloyloxyethyl)isocyanurate, hydroxypivalaldehyde modified dimethylolpropane tri(meth)acrylate, and sorbitol tri(meth)acrylate.

Specific examples of a tetrafunctional (meth)acrylate include pentaerythritol tetra(meth)acrylate, sorbitol tetra(meth)acrylate, ditrimethyloipropane tetra(meth)acrylate, dipentaerythritol propionate tetra(meth)acrylate, and ethoxylated pentaerythritol tetra(meth)acrylate.

Specific examples of a pentafunctional (meth)acrylate include sorbitol penta(meth)acrylate, and dipentaerythritol penta(meth)acrylate.

Specific examples of a hexafunctional (meth)acrylate include dipentaerythritol hexa(meth)acrylate, sorbitol hexa(meth)acrylate, phosphazene alkylene oxide modified hexa(meth)acrylate, and captolactone modified dipentaerythritol hexa(meth)acrylate.

Examples of the polymerizable compound other than the (meth)acrylate include an itaconic acid ester, a crotonic acid ester, an isocrotonic acid ester, and a maleic acid ester.

Examples of the itaconic acid ester include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of the crotonic acid ester include ethylene glycol dicrotonate, tetramethylene glycol dicrotonate, pentaerythritol dicrotonate, and sorbitol tetracrotonate.

Examples of the isocrotonic acid ester include ethylene glycol diisocrotonate, pentaerythritol diisocrotonate, and sorbitol tetraisocrotonate.

Examples of the maleic acid ester include ethylene glycol dimalate, triethylene glycol dimalate, pentaerythritol dimalate, and sorbitol tetramalate.

Specific examples of an amide monomer between an unsaturated carboxylic acid and an aliphatic amine compound include methylene bis-acrylamide, methylene bis-methacrylamide, 1,6-hexamethylene bis-acrylamide, 1,6-hexamethylene bis-methacrylamide, diethylenetriaminetris acrylamide, xylylene bis-acrylamide, xylylene bis-methacrylamide, and (meth)acryloyl morpholine. Examples of other preferable amide-based monomer include compounds having a cyclohexylene structure described in JP-B-54-21726.

In the invention, ring-opening cation polymerizable compounds having one or more cyclic ether groups such as an epoxy group and an oxetane group in the molecule can be preferably used as the ultraviolet curable resin (polymerizable compound). Examples of the cation polymerizable compound include curable compounds containing a ring-opening polymerizable group, and of these, curable compounds containing heterocyclic group are particularly preferable. Examples of such curable compounds include epoxy derivatives, oxetane derivatives, tetrahydrofuran derivatives, cyclic lactone derivatives, cyclic carbonate derivatives, cyclic imino ethers such as oxazoline derivatives, and vinyl ethers. Of these, the epoxy derivatives, the oxetane derivatives, and the vinyl ethers are preferable.

Examples of the preferable epoxy derivatives include monofunctional glycidyl ethers, polyfunctional glycidyl ethers, monofunctional alicyclic epoxies, and polyfunctional alicyclic epoxies. Examples of specific compounds of the glycidyl ethers include diglycidyl ethers (e.g., ethylene glycol diglycidyl ether and bisphenol A diglycidyl ether), glycidyl ethers having three or more functional groups (e.g., trimethylolethane triglycidyl ether, trimethylolpropane triglycidyl ether, glycerol triglycidyl ether, and triglycidyltris hydroxyethyl isocyanurate), glycidyl ethers having four or more functional groups (e.g., sorbitol tetraglycidyl ether, pentaerythritol tetraglycidyl ether, polyglycidyl ether of a cresol novolak resin, and polyglycidyl ether of a phenol novolak resin), alycyclic epoxies (e.g., Celloxide 2021P, Celloxide 2081, Epolead GT-301, Epolead GT-401 (these are available from Daicel Corporation), EHPE (available from Daicel Corporation), and polycyclohexyl epoxy methyl ether of phenol novolak resin), and oxetanes (e.g., OX-SQ and PNOX-1009 (these are available from Toagosei Co., Ltd.)).

The alicyclic epoxy derivatives can be preferably used as the polymerizable compound. The “alicyclic epoxy group” refers to a partial structure in which a double bond in a cycloalkene ring of a cyclopentene group, a cyclohexene group, or the like is epoxidized using an appropriate oxidizing agent such as hydrogen peroxide or peracid. Polyfunctional alicyclic epoxies having two or more cyclohexene oxide groups or cyclopentene oxide groups in one molecule are preferable as the alicyclic epoxy compound. Specific examples of the alicyclic epoxy compound include 4-vinylcyclohexene dioxide, (3,4-epoxycyclohexyl)methyl-3,4-epoxycyclohexyl carboxylate, di(3,4-epoxycyclohexyl)adipate, di(3,4-epoxycyclohexylmethyl)adipate, bis(2,3-epoxycyclopentyl)ether, di(2,3-epoxy-6-methylcyclohexylmethyl)adipate, and dicyclopentadiene dioxide.

Glycidyl compounds containing an ordinary epoxy group having no alicyclic structures in the molecule can be used alone or in combination with the alicyclic epoxy compounds. Examples of such ordinary glycidyl compounds include glycidyl ether compounds and glycidyl ester compounds, and it is preferable to use the glycidyl ether compounds in combination.

Specific examples of the glycidyl ether compounds include aromatic glycidyl ether compounds such as 1,3-bis(2,3-epoxypropyloxy)benzene, a bisphenol A epoxy resin, a bisphenol F epoxy resin, a phenol novolak epoxy resin, a cresol novolak epoxy resin, and a trisphenolmethane epoxy resin; and aliphatic glycidyl ether compounds such as 1,4-butanediol glycidyl ether, glycerol triglycidyl ether, propylene glycol diglycidyl ether, and trimethylolpropane triglycidyl ether. One example of the glycidyl ester is glycidyl ester of linoleic acid dimer. Compounds having an oxetanyl group that is a four membered-ring cyclic ether (also referred to as merely “oxetane compounds” hereinafter) can be used as the polymerizable compound. The oxetanyl group containing compound is a compound that has one or more oxetanyl groups in one molecule.

It is preferable that the object portion forming ink particularly contains one or more curable components selected from the group consisting of 2-(2-vinyloxyethoxy)ethyl (meth)acrylate, a polyether-based aliphatic urethane (meth)acrylate oligomer, 2-hydroxy-3-phenoxypropyl (meth)acrylate, and 4-hydroxybutyl (meth)acrylate out of the above curable components. This allows the object portion forming ink to be cured at a more appropriate curing speed, thus allowing the three-dimensional object to be particularly excellent in productivity. Moreover, the three-dimensional object can be given particularly excellent strength, durability, and reliability.

Moreover, the object portion forming ink contains these curable components, thus making it possible to reduce the solubility of the cured object portion forming ink in various solvents (e.g, water) and the swellability thereof to particularly low levels. As a result, in a process for removing a sacrificial layer, it is possible to more reliably remove the sacrificial layer at a high selectivity and to prevent unintentional deformation due to a defect occurring in the three-dimensional object, for example. As a result, it is possible to more reliably increase the accuracy of dimensions of the three-dimensional object.

The swellability (solvent absorptive property) of the cured product of the object portion forming ink can be reduced to a low level, thus making it possible to omit or simplify drying processing as post-processing subsequent to the process for removing the sacrificial layer, for example. In addition, the solvent resistance of the three-dimensional object, which is a final product, is also improved, and therefore, the reliability of the three-dimensional object becomes particularly high. In particular, when the object portion forming ink contains 2-(2-vinyloxyethoxy)ethyl (meth)acrylate, the object portion forming ink is not likely to suffer from oxygen inhibition and can be cured with low energy. Moreover, an effect of promoting copolymerization including other monomers and improving the strength of the modeled object can be obtained.

If the object portion forming ink contains a polyether-based aliphatic urethane (meth)acrylate oligomer, an effect of improving both the strength and the toughness of the modeled object can be obtained. If the object portion forming ink contains 2-hydroxy-3-phenoxypropyl (meth)acrylate, an effect of providing flexibility and improving a breaking elongation ratio is obtained. If the object portion forming ink contains 4-hydroxybutyl (meth)acrylate, an effect of improving the strength of the modeled object by improving adhesion to PMMA particles, PEMA particles, silica particles, and metal particles is obtained.

If the object portion forming ink contains the above specific curable components (one or more components selected from the group consisting of 2-(2-vinyloxyethoxy)ethyl (meth)acrylate, a polyether-based aliphatic urethane (meth)acrylate oligomer, 2-hydroxy-3-phenoxypropyl (meth)acrylate, and 4-hydroxybutyl (meth)acrylate), the ratio of the specific curable components to all of the curable components contained in the object portion forming ink is preferably 80 mass % or more, more preferably 90 mass % or more, and still more preferably 100 mass %. Accordingly, the above effects are more prominently exhibited.

The content of the curable components in the object portion forming ink is preferably 80 mass % or more and 97 mass % or less, and more preferably 85 mass % or more and 95 mass % or less. This allows the three-dimensional object, which is a final product, to be particularly excellent in mechanical strength. In addition, the three-dimensional object is particularly excellent in productivity. When the refractive index of the particles constituting the powder is defined as n1 and the refractive index of the cured product of the curable resin contained in the object portion forming ink is defined as n2, it is preferable that the relationship |n1−n2|≦0.2 is satisfied, and it is more preferable that the relationship |n1−n2|≦0.1 is satisfied. This makes it possible to more effectively prevent the diffusion of light on the outer surface of the manufactured three-dimensional object. As a result, a clearer color expression can be achieved.

Polymerization Initiator

It is preferable that the object portion forming ink contains a polymerization initiator. This makes it possible to increase the curing speed of the object portion forming ink during the manufacturing of the three-dimensional object, thus allowing the three-dimensional object to be particularly excellent in productivity.

Examples of the polymerization initiator include a photoradical polymerization initiator (e.g., aromatic ketones, acylphosphine oxide compounds, aromatic onium salt compounds, organic peroxides, thio compounds (thioxanthone compounds, thiophenyl group containing compound, and the like), hexaarylbiimidazole compounds, ketoxime ester compounds, borate compounds, azinium compounds, metallocene compounds, active ester compounds, compounds having a carbon-halogen bond, and alkylamine compounds) and a photocationic polymerization initiator. Specific examples thereof include acetophenone, acetophenone benzyl ketal, 1-hydroxycyclohexylphenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholino-propan-1-one, bis(2,4,6-trimethylbenzoyl)-phenylphosphine oxide, 2,4,6-trimethylbenzoyl-diphenyl-phosphine oxide, 2,4-diethylthioxanthone, and bis-(2,6-dimethoxybenzoyl)-2,4,4-trimethylpentylphosphine oxide. These compounds can be used alone or in combination of two or more. Of these, a polymerization initiator containing bis(2,4,6-trimethylbenzoyl)-phenylphosphine oxide or 2,4,6-trimethylbenzoyl-diphenyl-phosphine oxide is preferable as the polymerization initiator contained in the object portion forming ink.

The object portion forming ink contains such polymerization initiators, thus making it possible to cure the object portion forming ink at a more appropriate curing speed, allowing the three-dimensional object to be particularly excellent in productivity. Moreover, the three-dimensional object is particularly excellent in strength, durability, and reliability. In particular, when the object portion forming ink as well as the sacrificial layer forming ink, which will be specifically described later, contains bis(2,4,6-trimethylbenzoyl)-phenylphosphine oxide as the polymerization initiator, the curing speeds of the object portion forming ink and the sacrificial layer forming ink can be favorably controlled, thus allowing the three-dimensional object to be more excellent in productivity.

If the object portion forming ink as well as the sacrificial layer forming ink, which will be specifically described later, contains bis(2,4,6-trimethylbenzoyl)-phenylphosphine oxide as the polymerization initiator, it is preferable that the content of bis(2,4,6-trimethylbenzoyl)-phenylphosphine oxide in the object portion forming ink is higher than the content of bis(2,4,6-trimethylbenzoyl)-phenylphosphine oxide in the sacrificial layer forming ink. This makes it possible to cure the object portion forming ink and the sacrificial layer forming ink at more favorable speeds.

Although there is no particular limitation on the content of the polymerization initiator in the object portion forming ink, it is preferable that the content thereof is higher than the content of the polymerization initiator in the sacrificial layer forming ink. This makes it possible to cure the object portion forming ink and the sacrificial layer forming ink at more favorable speeds. Moreover, it is possible to cure the three-dimensional object to a sufficiently high degree and polymerize the sacrificial layer to a relatively low degree after the curing process by adjusting the processing conditions of the curing process, for example. As a result, it is possible to more easily remove the sacrificial layer in the sacrificial layer removing process, thus allowing the three-dimensional object to be particularly excellent in productivity. In addition, the dose of energy beams to be emitted need not be increased more than necessary, which is preferable from the viewpoint of saving energy.

In particular, when the content of the polymerization initiator in the object portion forming ink is defined as X1 (mass %) and the content of the polymerization initiator in the sacrificial layer forming ink is defined as X2 (mass %), it is preferable that the relationship 1.05≦X1/X2≦2.0 is satisfied, and it is more preferable that the relationship 1.1≦X1/X2≦1.5 is satisfied. This makes it possible to cure the object portion forming ink and the sacrificial layer forming ink at more favorable speeds, thus allowing the three-dimensional object to be more excellent in productivity.

The specific value of the content of the polymerization initiator in the object portion forming ink is preferably 3.0 mass % or more and 18 mass % or less, and more preferably 5.0 mass % or more and 15 mass % or less. This makes it possible to cure the object portion forming ink at a more appropriate curing speed, thus allowing the three-dimensional object to be particularly excellent in productivity. Moreover, a three-dimensional modeled object (object portion) 1 formed by curing the object portion forming ink can be particularly excellent in mechanical strength and stability of the shape. As a result, the three-dimensional object can be given particularly excellent strength, durability, and reliability.

Although the following is a preferred specific example of the mixing ratio of the curable resins and the polymerization initiators in the object portion forming ink (ink composition excluding “other components” described below), the composition of the object portion forming ink of the invention is not limited to the following composition.

Example of Mixing Ratio
2-(2-Vinyloxyethoxy)ethyl acrylate: 32 parts by mass
Polyether-based aliphatic urethane acrylate oligomer: 10 parts by mass
2-Hydroxy-3-phenoxypropyl acrylate: 13.75 parts by mass
Dipropylene glycol diacrylate: 15 parts by mass
4-Hydroxybutyl acrylate: 20 parts by mass
Bis(2,4,6-trimethylbenzoyl)-phenylphosphine oxide: 5 parts by mass
2,4,6-Trimethylbenzoyl-diphenyl-phosphine oxide: 4 parts by mass

When the components are mixed in this ratio, the above effects are more prominently exhibited.

Other Components

The object portion forming ink may contain components other than the above components. Examples of such components include various coloring agents such as pigments and dyes; a dispersant; a surfactant; a sensitizing agent; a polymerization promoter; a solvent; a permeation promoter; a wetting agent (humectant); a fixing agent; an antifungal agent; a preservative; an antioxidant; an ultraviolet absorber; a chelating agent; a pH adjusting agent; a thickening agent; a filler; an aggregation preventing agent; and an antifoaming agent.

In particular, if the object portion forming ink contains a coloring agent, a three-dimensional object colored in a color corresponding to the color of the coloring agent can be obtained. In particular, if the object portion forming ink contains a pigment as the coloring agent, the light fastness of the object portion forming ink and the three-dimensional object can be made favorable. Both an inorganic pigment and an organic pigment can be used as the pigment.

Examples of the inorganic pigment include carbon black (C.I. Pigment Black 7) such as furnace black, lampblack, acetylene black, and channel black; iron oxide; and titanium oxide. These pigments can be used alone or in combination of two or more. Of the inorganic pigments, titanium oxide is preferable in order to provide a favorable white color.

Examples of the organic pigment include an azo pigment such as an insoluble azo pigment, a condensed azo pigment, an azo lake, or a chelate azo pigment; a polycyclic pigment such as a phthalocyanine pigment, a perylene pigment, a perinone pigment, an anthraquinone pigment, a quinacridone pigment, a dioxane pigment, a thioindigo pigment, an isoindolinone pigment, or a quinophthalone pigment; a dye chelate (e.g., a basic dye-type chelate and an acid dye-type chelate); a dye lake (a basic dye-type lake and an acid dye-type lake); a nitro pigment; a nitroso pigment; aniline black; and a daylight fluorescent pigment. These pigments can be used alone or in combination of two or more.

More specifically, examples of the carbon black used as a black pigment include No. 2300, No. 900, MCF88, No. 33, No. 40, No. 45, No. 52, MA7, MA8, MA100, No. 2200B, and the like (these are available from Mitsubishi Chemical Corporation); Raven 5750, Raven 5250, Raven 5000, Raven 3500, Raven 1255, Raven 700, and the like (these are available from Carbon Columbia); Regal 400R, Regal 330R, Regal 660R, Mogul L, Monarch 700, Monarch 800, Monarch 880, Monarch 900, Monarch 1000, Monarch 1100, Monarch 1300, Monarch 1400, and the like (these are available from CABOT JAPAN K. K.); and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (these are available from Degussa).

Examples of a white pigment include C.I. Pigment White 6, 18, and 21.

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224 and 245, and C.I. Pigment Violet 19, 23, 32, 33, 36, 38, 43, and 50.

Examples of a cyan pigment include C.I. Pigment Blue 1, 2, 3, 15, 15:1, 15:2, 15:3, 15:34, 15:4, 16, 18, 22, 25, 60, 65, and 66, and C.I. Vat Blue 4, and 60.

In addition, examples of pigments other than the above pigments include C.I. Pigment Green 7 and 10, C.I. Pigment Brown 3, 5, 25 and 26, and C.I. Pigment Orange 1, 2, 5, 7, 13, 14, 15, 16, 24, 34, 36, 38, 40, 43, and 63.

If the object portion forming ink contains a pigment, the average particle size of the pigment is preferably 300 nm or less, and more preferably 50 nm or more and 250 nm or less. This allows the object portion forming ink to be particularly excellent in discharge stability, thus allowing the pigment to be particularly excellent in dispersion stability in the object portion forming ink. Furthermore, it is possible to form an image with superior image quality.

Examples of the dye include an acid dye, a direct dye, a reactive dye, and a basic dye, and these dyes can be used alone or in combination of two or more. Specific examples of the dye include C.I. Acid Yellow 17, 23, 42, 44, 79, and 142; C.I. Acid Red 52, 80, 82, 249, 254, and 289; C.I. Acid Blue 9, 45, and 249; C.I. Acid Black 1, 2, 24, and 94; C.I. Food Black 1, and 2; C.I. Direct Yellow 1, 12, 24, 33, 50, 55, 58, 86, 132, 142, 144, and 173; C.I. Direct Red 1, 4, 9, 80, 81, 225, and 227; C.I. Direct Blue 1, 2, 15, 71, 86, 87, 98, 165, 199, and 202; C.I. Direct Black 19, 38, 51, 71, 154, 168, 171, and 195; C.I. Reactive Red 14, 32, 55, 79, and 249; and C.I. Reactive Black 3, 4, and 35.

If the object portion forming ink contains a coloring agent, it is preferable that the content of the coloring agent in the object portion forming ink is 1 mass % or more and 20 mass % or less. Accordingly, particularly excellent concealing property and color reproducibility can be obtained. In particular, if the object portion forming ink contains titanium oxide as the coloring agent, the content of the titanium oxide in the object portion forming ink is preferably 12 mass % or more and 18 mass % or less, and more preferably 14 mass % or more and 16 mass % or less. Accordingly, a particularly excellent concealing property can be obtained.

If the object portion forming ink containing a pigment further contains a dispersant, the pigment can be more favorably dispersed. Examples of the dispersant include dispersants such as a polymeric dispersant that are commonly used to prepare a pigment dispersing liquid, but are not particularly limited thereto.

Specific examples of the polymeric dispersant include dispersants containing, as a main component, one or more of polyoxyalkylenepolyalkylenepolyamine, vinyl-based polymer and copolymer, acrylic polymer and copolymer, polyester, polyamide, polyimide, polyurethane, an amino-based polymer, a silicon-containing polymer, a sulfur-containing polymer, a fluorine-containing polymer and an epoxy resin.

If the object portion forming ink contains a surfactant, the three-dimensional object can be given a more favorable rubbing resistance. Examples of the surfactant include silicone-based surfactants such as polyester modified silicone and polyether modified silicone, but are not particularly limited thereto. Of these, it is preferable to use polyether modified polydimethylsiloxane or polyester modified polydimethylsiloxane.

The object portion forming ink may contain a solvent. This makes it possible to favorably adjust the viscosity of the object portion forming ink, and even if the object portion forming ink contains a highly viscous component, the stability of discharge of the object portion forming ink in an inkjet system can be made particularly excellent. Examples of the solvent include (poly)alkylene glycol monoalkyl ethers such as ethylene glycol monomethyl ether, ethylene glycol monoethyl ether, propylene glycol monomethyl ether, and propylene glycol monoethyl ether; acetate esters such as ethyl acetate, n-propyl acetate, iso-propyl acetate, n-butyl acetate, and iso-butyl acetate; aromatic hydrocarbons such as benzene, toluene, and xylene; ketones such as methylethyl ketone, acetone, methylisobutyl ketone, ethyl-n-butyl ketone, diisopropyl ketone, and acetylacetone; and alcohols such as ethanol, propanol, and butanol. These solvents can be used alone or in combination of two or more.

The viscosity of the object portion forming ink is preferably 10 mPa·s or more and 30 mPa·s or less, and more preferably 15 mPa·s or more and 25 mPa·s or less. Accordingly, the stability of discharge of the object portion forming ink in an inkjet system can be made particularly excellent. It should be noted that viscosity in this specification refers to a value measured with an E-type viscometer (“VISCONIC ELD” available from Tokyo Keiki Inc.) at 25° C.

A plurality of types of object portion forming ink may be used to manufacture a three-dimensional object. Object portion forming ink (color ink) containing a coloring agent and object portion forming ink (clear ink) containing no coloring agent may be used, for example. This makes it possible to use the object portion forming ink containing a coloring agent as the object portion forming ink to be applied to a region that affects a color tone of the external appearance of the three-dimensional object and to use the object portion forming ink containing no coloring agent as the object portion forming ink to be applied to a region that does not affect a color tone of the external appearance of the three-dimensional object, for example, which is advantageous from the viewpoint of reducing the production cost of the three-dimensional object, and the like.

A plurality of types of object portion forming ink may be used in combination such that a region (coating layer) made of the object portion forming ink containing no coloring agent is provided on the outer surface of a region made of the object portion forming ink containing a coloring agent in the three-dimensional object, which is a final product. A portion containing a coloring agent (particularly pigment) is more brittle than a portion containing no coloring agent, and scratches and chips easily. However, if the region (coating layer) made of the object portion forming ink containing no coloring agent is provided, it is possible to effectively prevent such problems from arising. Moreover, even if the surface is worn due to the three-dimensional object being used for a long period of time, it is possible to effectively prevent and suppress the change in the color tone of the three-dimensional object. Furthermore, a plurality of types of object portion forming ink that contain coloring agents that differ in the composition may be used. This makes it possible to broaden an expressible color reproduction region by using the different types of object portion forming ink in combination.

If a plurality of types of object portion forming ink are used, it is preferable to use at least cyan object portion forming ink, magenta object portion forming ink, and yellow object portion forming ink. Using these types of object portion forming ink in combination makes it possible to broaden an expressible color reproduction region,

When white object portion forming ink and another color of object portion forming ink are used in combination, the following effect is obtained, for example. That is, the three-dimensional object, which is a final product, can be formed so as to have a first region to which the white object portion forming ink is applied and a region (second region) that is provided on the outer surface side with respect to the first region and to which the colored object portion forming ink other than the white object portion forming ink is applied. Accordingly, the first region to which the white object portion forming ink is applied can exhibit a concealing property, thus making it possible to further increase the chroma of the three-dimensional object.

B2. Sacrificial Layer Forming Ink

Curable Resin

The sacrificial layer forming ink contains at least a curable resin (curable component). Examples of the curable resin (curable component) contained in the sacrificial layer forming ink include curable resins (curable components) similar to those shown as the examples of the components of the object portion forming ink.

In particular, it is preferable that the curable resin (curable component) contained in the sacrificial layer forming ink and the curable resin (curable component) contained in the above object portion forming ink are cured with the same type of energy beam. This makes it possible to effectively prevent the configuration of an apparatus for manufacturing a three-dimensional modeled object from being complicated, thus allowing the three-dimensional object to be particularly excellent in productivity. In addition, it is possible to more reliably control the surface shape of the three-dimensional object. Moreover, it is preferable to use sacrificial layer forming ink from which a hydrophilic cured product is formed. This makes it easy to remove the sacrificial layer using an aqueous liquid such as water.

It is preferable that the sacrificial layer forming ink particularly contains, of various curable components, one or more curable components selected from the group consisting of tetrahydrofurfuryl (meth)acrylate, ethoxyethoxyethyl (meth)acrylate, polyethylene glycol di(meth)acrylate, (meth)acryloylmorpholine, and 2-(2-vinyloxyethoxy)ethyl (meth)acrylate. This makes it possible to cure the sacrificial layer forming ink at a more appropriate curing speed, thus allowing the three-dimensional object to be particularly excellent in productivity. Moreover, the cured product can be given a more favorable hydrophilicity, thus making it easy to remove the sacrificial layer.

In addition, the sacrificial layer formed by curing the sacrificial layer forming ink can be particularly excellent in mechanical strength and stability of the shape. As a result, the sacrificial layer, which is a lower layer (first layer), can more favorably support the object portion forming ink for forming an upper layer (second layer) during the manufacturing of the three-dimensional object. Therefore, it is possible to more favorably prevent unintentional deformation (particularly shear drop and the like) of the three-dimensional object (that is, the sacrificial layer, which is the first layer, functions as a supporting material), thus allowing the three-dimensional object, which is a final product, to be more excellent in accuracy of the dimensions. In particular, when the sacrificial layer forming ink contains (meth)acryloylmorpholine, the following effects are obtained.

That is, even when a curing reaction proceeds, in a state in which (meth)acryloylmorpholine is not completely cured, (meth)acryloylmorpholine (polymer of (meth)acryloylmorpholine that is not completely cured) has high solubility in various solvents such as water. Therefore, in the sacrificial layer removing process as described above, it is possible to more effectively prevent the occurrence of a defect in the object portion and to remove the sacrificial layer selectively, reliably and efficiently. As a result, the three-dimensional object having a desired shape can be obtained with higher reliability and productivity.

When the sacrificial layer forming ink contains tetrahydrofurfuryl (meth)acrylate, flexibility is retained after the ink is cured, and an effect of improving removability due to the sacrificial layer easily gelating with the treatment using a liquid for removing the sacrificial layer is obtained.

If the sacrificial layer forming ink contains ethoxyethoxyethyl (meth)acrylate, tackiness easily remains after the ink is cured, and an effect of improving removability of the liquid for removing the sacrificial layer is obtained.

If the sacrificial layer forming ink contains polyethylene glycol di(meth)acrylate, in a case where the liquid for removing the sacrificial layer contains water as a main component, an effect of improving the solubility of the sacrificial layer in the liquid and facilitating removing the sacrificial layer is obtained.

If the sacrificial layer forming ink contains the above specific curable components (one or more curable components selected from the group consisting of tetrahydrofurfuryl (meth)acrylate, ethoxyethoxyethyl (meth)acrylate, polyethylene glycol di(meth)acrylate, and (meth)acryloylmorpholine), the ratio of the specific curable components to all of the curable components contained in the sacrificial layer forming ink is preferably 80 mass % or more, more preferably 90 mass % or more, and still more preferably 100 mass %. Accordingly, the above effects are more prominently exhibited.

The content of the curable components in the sacrificial layer forming ink is preferably 83 mass % or more and 98.5 mass % or less, and more preferably 87 mass % or more and 95.4 mass % or less. This allows the sacrificial layer formed to be particularly excellent in stability of the shape. Therefore, when the cross section bodies are laminated during the manufacturing of the three-dimensional object, it is possible to more effectively prevent unintentional deformation of the cross section bodies on the lower side, and thus the cross section bodies on the upper side can be favorably supported. As a result, the three-dimensional object, which is a final product, can be particularly excellent in accuracy of the dimensions. Moreover, the three-dimensional object can be particularly excellent in productivity.

Polymerization Initiator

It is preferable that the sacrificial layer forming ink contains a polymerization initiator. This makes it possible to appropriately increase the curing speed of the sacrificial layer forming ink during the manufacturing of the three-dimensional object, thus allowing the three-dimensional object to be particularly excellent in productivity. Moreover, the sacrificial layer formed can be particularly excellent in stability of the shape. Therefore, when the cross section bodies are laminated during the manufacturing of the three-dimensional object, it is possible to more effectively prevent unintentional deformation of the cross section bodies on the lower side, and thus the cross section bodies on the upper side can be favorably supported. As a result, the three-dimensional object, which is a final product, can be particularly excellent in accuracy of the dimensions.

Examples of the polymerization initiator contained in the sacrificial layer forming ink include polymerization initiators similar to those shown as the examples of the components of the object portion forming ink. Of these, it is preferable that the sacrificial layer forming ink contains bis(2,4,6-trimethylbenzoyl)-phenylphosphine oxide or 2,4,6-trimethylbenzoyl-diphenyl-phosphine oxide as the polymerization initiator. When the sacrificial layer forming ink contains such polymerization initiators, the sacrificial layer forming ink can be cured at a more appropriate curing speed, thus allowing the three-dimensional object to be particularly excellent in productivity.

In addition, the sacrificial layer formed by curing the sacrificial layer forming ink can be particularly excellent in mechanical strength and stability of the shape. As a result, the sacrificial layer, which is a lower layer (first layer), can more favorably support the object portion forming ink for forming an upper layer (second layer) during the manufacturing of the three-dimensional object. Therefore, it is possible to more favorably prevent unintentional deformation (particularly shear drop and the like) of the object portion (that is, the sacrificial layer, which is the first layer, functions as a supporting material), thus allowing the three-dimensional object, which is a final product, to be more excellent in accuracy of the dimensions.

The specific value of the content of the polymerization initiator in the sacrificial layer forming ink is preferably 1.5 mass % or more and 17 mass % or less, and more preferably 4.6 mass % or more and 13 mass % or less. This makes it possible to cure the sacrificial layer forming ink at a more appropriate curing speed, thus allowing the three-dimensional object to be particularly excellent in productivity.

In addition, the sacrificial layer formed by curing the sacrificial layer forming ink can be particularly excellent in mechanical strength and stability of the shape. As a result, the sacrificial layer, which is a lower layer (first layer), can more favorably support the object portion forming ink for forming an upper layer (second layer) during the manufacturing of the three-dimensional object. Therefore, it is possible to more favorably prevent unintentional deformation (particularly shear drop and the like) of the object portion (that is, the sacrificial layer, which is the first layer, functions as a supporting material), thus allowing the three-dimensional object, which is a final product, to be more excellent in accuracy of the dimensions.

Although the following are preferred specific examples of the mixing ratio of the curable resins and the polymerization initiators in the sacrificial layer forming ink (ink composition excluding “other components” described below), the composition of the sacrificial layer forming ink of the invention is not limited to the following composition.

Example 1 of Mixing Ratio
Tetrahydrofurfuryl acrylate: 36 parts by mass
Ethoxyethoxyethyl acrylate: 55.75 parts by mass
Bis(2,4,6-trimethylbenzoyl)-phenylphosphine oxide: 3 parts by mass
2,4,6-Trimethylbenzoyl-diphenyl-phosphine oxide: 5 parts by mass

Example 2 of Mixing Ratio
Dipropylene glycol diacrylate: 37 parts by mass
Polyethylene glycol (400) diacrylate: 55.85 parts by mass
Bis(2,4,6-trimethylbenzoyl)-phenylphosphine oxide: 3 parts by mass
2,4,6-Trimethylbenzoyl-diphenyl-phosphine oxide: 4 parts by mass

Example 3 of Mixing Ratio
Tetrahydrofurfuryl acrylate: 36 parts by mass
Acryloylmorpholine: 55.75 parts by mass
Bis(2,4,6-trimethylbenzoyl)-phenylphosphine oxide: 3 parts by mass
2,4,6-Trimethylbenzoyl-diphenyl-phosphine oxide: 5 parts by mass

Example 4 of Mixing Ratio
2-(2-Vinyloxyethoxy)ethyl acrylate: 36 parts by mass
Polyethylene glycol (400) diacrylate: 55.75 parts by mass
Bis(2,4,6-trimethylbenzoyl)-phenylphosphine oxide: 3 parts by mass
2,4,6-Trimethylbenzoyl-diphenyl-phosphine oxide: 5 parts by mass

When the components are mixed in these ratios, the above effects are more prominently exhibited.

Other Components

The sacrificial layer forming ink may contain components other than the above components. Examples of such components include various coloring agents such as pigments and dyes; a dispersant; a surfactant; a sensitizing agent; a polymerization promoter; a solvent; a permeation promoter; a wetting agent (humectant); a fixing agent; an antifungal agent; a preservative; an antioxidant; an ultraviolet absorber; a chelating agent; a pH adjusting agent; a thickening agent; a filler; an aggregation preventing agent; and an antifoaming agent. In particular, when the sacrificial layer forming ink contains a coloring agent, the visibility of the sacrificial layer is improved, thus making it possible to reliably prevent at least a portion of the sacrificial layer from unintentionally remaining in the three-dimensional object, which is a final product.

Although examples of the coloring agent contained in the sacrificial layer forming ink include coloring agents similar to those shown as the examples of the components of the object portion forming ink, it is preferable to use a coloring agent for applying a color that is different from a color of the object portion overlapping the sacrificial layer made of the sacrificial layer forming ink (a color that is visible on the exterior of the three-dimensional object) when the three-dimensional object is viewed in the direction of the normal line of its surface. Accordingly, the above effects are more prominently exhibited.

If the sacrificial layer forming ink containing a pigment further contains a dispersant, the pigment can be more favorably dispersed. Examples of the dispersant contained in the sacrificial layer forming ink include dispersants similar to those shown as the examples of the components of the object portion forming ink. The viscosity of the sacrificial layer forming ink is preferably 10 mPa·s or more and 30 mPa·s or less, and more preferably 15 mPa·s or more and 25 mPa·s or less. Accordingly, the stability of discharge of the sacrificial layer forming ink in an inkjet system can be made particularly excellent.

### C. Composition of Powder Composition

The powder composition (powder-containing composition) of the embodiment contains powder and a water-soluble resin. Hereinafter, each component will be described in detail.

Powder

The powder is constituted by a plurality of particles. Although any particles can be used as the particles, it is preferable that the powder is constituted by particles having a large number of pores (porous particles). This allows the curable resin to favorably enter the pores during the manufacturing of the three-dimensional object, and as a result, the powder can be favorably used to manufacture a three-dimensional modeled object that is excellent in mechanical strength.

Examples of the components of the porous particles constituting the powder include inorganic materials, organic materials, or complexes thereof. Examples of the inorganic material included in the porous particles include various metals and metal compounds. Examples of the metal compounds include various metal oxides such as silica, alumina, titanium oxide, zinc oxide, zirconium oxide, tin oxide, magnesium oxide, and potassium titanate; various metal hydroxides such as magnesium hydroxide, aluminum hydroxide, and calcium hydroxide; various metal nitrides such as silicon nitride, titanium nitride, and aluminum nitride; various metal carbides such as silicon carbide and titanium carbide; various metal sulfides such as zinc sulfide; carbonates of various metals such as calcium carbonate and magnesium carbonate; sulfates of various metals such as calcium sulfate and magnesium sulfate; silicates of various metals such as calcium silicate and magnesium silicate; phosphates of various metals such as calcium phosphate; and borates of various metals such as aluminum borate and magnesium borate; or a complex thereof.

Examples of the organic material included in the porous particles include a synthetic resin and a natural macromolecule. Specific examples thereof include a polyethylene resin; polypropylene; polyethylene oxide; polypropylene oxide, polyethylene imine; polystyrene; polyurethane; polyurea; polyester; a silicone resin; an acrylic silicone resin; a polymer such as polymethyl methacrylate containing (meth)acrylate ester as a constituent monomer; a crosspolymer such as methyl methacrylate crosspolymer containing (meth)acrylate ester as a constituent monomer (e.g., ethylene-acrylic acid copolymer resin); a polyamide resin such as nylon 12, nylon 6 or copolymerized nylon; polyimide; carboxymethylcellulose; gelatin; starch; chitin; and chitosan.

Of these, the porous particles are preferably made of an inorganic material, more preferably made of a metal oxide, and still more preferably made of silica. This allows the three-dimensional modeled object to be particularly excellent in properties such as mechanical strength and lightfastness. In particular, when the porous particles are made of silica, the above effects are more prominently exhibited. Moreover, since silica has excellent fluidity, silica is advantageous for forming a layer having a more uniform thickness, thus allowing the three-dimensional object to be particularly excellent in productivity and accuracy of the dimensions.

It is preferable to use hydrophobized porous particles. Incidentally, the object portion forming ink and the sacrificial layer forming ink generally tend to contain hydrophobic curable resins. Therefore, the hydrophobized porous particles allow the curable resins to more favorably enter the pores of the porous particles. As a result, an anchor effect is more prominently exhibited, thus allowing the three-dimensional object obtained to be further excellent in mechanical strength. Moreover, the hydrophobized porous particles can be favorably reused. More specifically, when the hydrophobized porous particles are used, the affinity of the water-soluble resin, which will be specifically described later, for the porous particles decreases, thus preventing the water-soluble resin from entering the pores. As a result, impurities can be easily removed, by washing with water or the like, from the porous particles located in a region to which no ink is applied during the manufacturing of the three-dimensional object, thus making it possible to recover the porous particles in high purity. Accordingly, by mixing the recovered powder with the water-soluble resin or the like at a predetermined ratio again, powder that is reliably controlled to have a desired composition can be obtained.

Although any hydrophobizing treatment may be performed on the porous particles included in the powder as long as the treatment increases the hydrophobicity of the porous particles, treatment for introducing a hydrocarbon group is preferable. This makes it possible to further increase the hydrophobicity of the particles. Moreover, it is possible to easily and reliably increase the uniformity of the degree of the hydrophobizing treatment of the particles or portions of the surfaces of the particles (including the inner surfaces of the pores).

A silane compound containing a silyl group is preferable as a compound to be used in the hydrophobizing treatment. Specific examples of compounds that can be used in the hydrophobizing treatment include hexamethyldisilazane, dimethyldimethoxysilane, diethyldiethoxysilane, 1-propenylmethyldichlorosilane, propyldimethylchlorosilane, propylmethyldichlorosilane, propyltrichlorosilane, propyltriethoxysilane, propyltrimethoxysilane, styrylethyltrimethoxysilane, tetradecyltrichlorosilane, 3-thiocyanatepropyltriethoxysilane, p-tolyldimethylchlorosilane, p-tolylmethyldichiorosilane, p-tolyltrichlorosilane, p-tolyltrimethoxysilane, p-tolyltriethoxysilane, di-n-propyldi-n-propoxysilane, diisopropyldiisopropoxysilane, di-n-butyldi-n-butyloxysilane, di-sec-butyldi-sec-butyloxysilane, di-t-butyldi-t-butyloxysilane, octadecyltrichlorosilane, octadecylmethyldiethoxysilane, octadecyltriethoxysilane, octadecyltrimethoxysilane, octadecyldimethylchlorosilane, octadecylmethyldichlorosilane, octadecylmethoxydichlorosilane, 7-octenyldimethylchlorosilane, 7-octenyltrichlorosilane, 7-octenyltrimethoxysilane, octylmethyldichlorosilane, octyldimethylchlorosilane, octyltrichlorosilane, 10-undecenyldimethylchlorosilane, undecyltrichlorosilane, vinyldimethylchlorosilane, methyloctadecyldimethoxysilane, methyldodecyldiethoxysilane, methyloctadecyldimethoxysilane, methyloctadecyldiethoxysilane, n-octylmethyldimethoxysilane, n-octylmethyldiethoxysilane, triacontyldimethylchlorosilane, triacontyltrichlorosilane, methyltrimethoxysilane, methyltriethoxysilane, methyltri-n-propoxysilane, methylisopropoxysilane, methyl-n-butyloxysilane, methyltri-sec-butyloxysilane, methyltri-t-butyloxysilane, ethyltrimethoxysilane, ethyltriethoxysilane, ethyltri-n-propoxysilane, ethylisopropoxysilane, ethyl-n-butyloxysilane, ethyltri-sec-butyloxysilane, ethyltri-t-butyloxysilane, n-propyltrimethoxysilane, isobutyltrimethoxysilane, n-hexyltrimethoxysilane, hexadecyltrimethoxysilane, n-octyltrimethoxysilane, n-dodecyltrimethoxysilane, n-octadecyltrimethoxysilane, n-propyltriethoxysilane, isobutyltriethoxysilane, n-hexyltriethoxysilane, hexadecyltriethoxysilane, n-octyltriethoxysilane, n-dodecyltrimethoxysilane, n-octadecyltriethoxysilane, 2-[2-(trichlorosilyl)ethyl]pyridine, 4-[2-(trichlorosilyl)ethyl]pyridine, diphenyldimethoxysilane, diphenyldiethoxysilane, 1,3-(trichlorosilylmethyl)heptacosane, dibenzyldimethoxysilane, dibenzyldiethoxysilane, phenyltrimethoxysilane, phenylmethyldimethoxysilane, phenyldimethylmethoxysilane, phenyldimethoxysilane, phenyldiethoxysilane, phenylmethyldiethoxysilane, phenyldimethylethoxysilane, benzyltriethoxysilane, benzyltrimethoxysilane, benzylmethyldimethoxysilane, benzyldimethylmethoxysilane, benzyldimethoxysilane, benzyldiethoxysilane, benzylmethyldiethoxysilane, benzyldimethylethoxysilane, benzyltriethoxysilane, dibenzyldimethoxysilane, dibenzyldiethoxysilane, 3-acetoxypropyltrimethoxysilane, 3-acryloxypropyltrimethoxysilane, allyltrimethoxysilane, allyltriethoxysilane, 4-aminobutyltriethoxysilane, (aminoethylaminomethyl)phenethyltrimethoxysilane, N-(2-aminoethyl)-3-aminopropylmethyldimethoxysilane, N-(2-aminoethyl)-3-aminopropyltrimethoxysilane, 6-(aminohexylaminopropyl)trimethoxysilane, p-aminophenyltrimethoxysilane, p-aminophenylethoxysilane, m-aminophenyltrimethoxysilane, m-aminophenylethoxysilane, 3-aminopropyltrimethoxysilane, 3-aminopropyltriethoxysilane, ω-aminoundecyltrimethoxysilane, amyltriethoxysilane, benzoxasilepindimethylester, 5-(bicycloheptenyl)triethoxysilane, bis(2-hydroxyethyl)-3-aminopropyltriethoxysilane, 8-bromooctyltrimethoxysilane, bromophenyltrimethoxysilane, 3-bromopropyltrimethoxysilane, n-butyltrimethoxysilane, 2-chloromethyltriethoxysilane, chloromethylmethyldiethoxysilane, chloromethylmethyldiisopropoxysilane, p-(chloromethyl)phenyltrimethoxysilane, chloromethyltriethoxysilane, chlorophenyltriethoxysilane, 3-chloropropylmethyldimethoxysilane, 3-chloropropyltriethoxysilane, 3-chloropropyltrimethoxysilane, 2-(4-chlorosulfonylphenyl)ethyltrimethoxysilane, 2-cyanoethyltriethoxysilane, 2-cyanoethyltrimethoxysilane, cyanomethylphenethyltriethoxysilane, 3-cyanopropyltriethoxysilane, 2-(3-cyclohexenyl)ethyltrimethoxysilane, 2-(3-cyclohexenyl)ethyltriethoxysilane, 3-cyclohexenyltrichlorosilane, 2-(3-cyclohexenyl)ethyltrichlorosilane, 2-(3-cyclohexenyl)ethyldimethylchlorosilane, 2-(3-cyclohexenyl)ethylmethyldichlorosilane, cyclohexyldimethylchlorosilane, cyclohexylethyldimethoxysilane, cyclohexylmethyldichiorosilane, cyclohexylmethyldimethoxysilane, (cyclohexylmethyl)trichlorosilane, cyclohexyltrichlorosilane, cyclohexyltrimethoxysilane, cyclooctyltrichlorosilane, (4-cyclooctenyl)trichlorosilane, cyclopentyltrichlorosilane, cyclopentyltrimethoxysilane, 1,1-diethoxy-1-silacyclopenta-3-en, 3-(2,4-dinitrophenylamino)propyltriethoxysilane, (dimethylchlorosilyl)methyl-7,7-dimethylnorpinane, (cyclohexylaminomethyl)methyldiethoxysilane, (3-cyclopentadienylpropyl)triethoxysilane, N,N-diethyl-3-aminopropyl)trimethoxysilane, 2-(3,4-epoxycyclohexyl)ethyltrimethoxysilane, 2-(3,4-epoxycyclohexyl)ethyltriethoxysilane, (furfuryloxymethyl)triethoxysilane, 2-hydroxy-4-(3-triethoxypropoxy)diphenylketone, 3-(p-methoxyphenyl)propylmethyldichlorosilane, 3-(p-methoxyphenyl)propyltrichlorosilane, p-(methylphenethyl)methyldichlorosilane, p-(methylphenethyl)trichlorosilane, p-(methylphenethyl)dimethylchlorosilane, 3-morpholinopropyltrimethoxysilane, (3-glycidoxypropyl)methyldiethoxysilane, 3-glycidoxypropyltrimethoxysilane, 1,2,3,4,7,7,-hexachloro-6-methyldiethoxysilyl-2-norbornene, 1,2,3,4,7,7,-hexachloro-6-triethoxysilyl-2-norbornene, 3-iodopropyltrimethoxysilane, 3-isocyanatepropyltriethoxysilane, (mercaptomethyl)methyldiethoxysilane, 3-mercaptopropylmethyldimethoxysilane, 3-mercaptopropyldimethoxysilane, 3-mercaptopropyltriethoxysilane, 3-methacryloxypropylmethyldiethoxysilane, 3-methacryloxypropyltrimethoxysilane, methyl{2-(3-trimethoxysilylpropylamino)ethylamino}-3-propionate, 7-octenyltrimethoxysilane, R—N-α-phenethyl-N′-triethoxysilylpropylurea, S—N-α-phenethyl-N′-triethoxysilylpropylurea, phenethyltrimethoxysilane, phenethylmethyldimethoxysilane, phenethyldimethylmethoxysilane, phenethyldimethoxysilane, phenethyldiethoxysilane, phenethylmethyldiethoxysilane, phenethyldimethylethoxysilane, phenethyltriethoxysilane, (3-phenylpropyl)dimethylchlorosilane, (3-phenylpropyl)methyldichlorosilane, N-phenylaminopropyltrimethoxysilane, N-(triethoxysilylpropyl)dansylamide, N-(3-triethoxysilylpropyl)-4,5-dihydroimidazole, 2-(triethoxysilylethyl)-5-(chloroacetoxy)bicycloheptane, (S)—N-triethoxysilylpropyl-O-menthocarbamate, 3-(triethoxysilylpropyl)-p-nitrobenzamide, 3-(triethoxysilyl)propylsuccinic anhydride, N-[5-(trimethoxysilyl)-2-aza-1-oxo-pentyl]caprolactam, 2-(trimethoxysilylethyl)pyridine, N-(trimethoxysilylethyl)benzyl-N,N,N-trimethylammonium chloride, phenylvinyldiethoxysilane, 3-thiocyanatepropyltriethoxysilane, (tridecafluoro-1,1,2,2,-tetrahydrooctyl)triethoxysilane, N-{3-(triethoxysilyl)propyl}phthalamidic acid, (3,3,3-trifluoropropyl)methyldimethoxysilane, (3,3,3-trifluoropropyl)trimethoxysilane, 1-trimethoxysilyl-2-(chloromethyl)phenylethane, 2-(trimethoxysilyl)ethylphenylsulfonylazide, β-trimethoxysilylethyl-2-pyridine, trimethoxysilylpropyldiethylenetriamine, N-(3-trimethoxysilylpropyl)pyrrole, N-trimethoxysilylpropyl-N, N, N-tributylammonium bromide, N-trimethoxysilylpropyl-N, N, N-tributylammonium chloride, N-trimethoxysilylpropyl-N,N,N-trimethylammonium chloride, vinylmethyldiethoxysilane, vinyltriethoxysilane, vinyltrimethoxysilane, vinylmethyldimethoxysilane, vinyldimethylmethoxysilane, vinyldimethylethoxysilane, vinylmethyldichlorosilane, vinylphenyldichiorosilane, vinylphenyldiethoxysilane, vinylphenyldimethylsilane, vinylphenylmethylchlorosilane, vinyltriphenoxysilane, vinyltris-t-butoxysilane, adamantylethyltrichlorosilane, allylphenyltrichlorosilane, (aminoethylaminomethyl)phenethyltrimethoxysilane, 3-aminophenoxydimethylvinylsilane, phenyltrichlorosilane, phenyldimethylchlorosilane, phenylmethyldichlorosilane, benzyltrichlorosilane, benzyldimethylchlorosilane, benzylmethyldichlorosilane, phenethyldiisopropylchlorosilane, phenethyltrichlorosilane, phenethyldimethylchlorosilane, phenethylmethyldichlorosilane, 5-(bicycloheptenyl)trichlorosilane, 5-(bicycloheptenyl)triethoxysilane, 2-(bicycloheptyl)dimethylchlorosilane, 2-(bicycloheptyl)trichlorosilane, 1,4-bis(trimethoxysilylethyl)benzene, bromophenyltrichlorosilane, 3-phenoxypropyldimethylchlorosilane, 3-phenoxypropyltrichlorosilane, t-butylphenylchlorosilane, t-butylphenylmethoxysilane, t-butylphenyldichlorosilane, p-(t-butyl)phenethyldimethylchlorosilane, p-(t-butyl)phenethyltrichlorosilane, 1,3-(chlorodimethylsilylmethyl)heptacosane, ((chloromethyl)phenylethyl)dimethylchlorosilane, ((chloromethyl)phenylethyl)methyldichlorosilane, ((chloromethyl)phenylethyl)trichlorosilane, ((chloromethyl)phenylethyl)trimethoxysilane, chlorophenyltrichlorosilane, 2-cyanoethyltrichlorosilane, 2-cyanoethylmethyldichlorosilane, 3-cyanopropylmethyldiethoxysilane, 3-cyanopropylmethyldichlorosilane, 3-cyanopropylmethyldichlorosilane, 3-cyanopropyldimethylethoxysilane, 3-cyanopropylmethyldichlorosilane, 3-cyanopropyltrichlorosilane, and alkylsilane fluoride. These compounds can be used alone or in combination of two or more.

Of these, it is preferable to use hexamethyldisilazane in the hydrophobizing treatment. This makes it possible to further increase the hydrophobicity of the particles. Moreover, it is possible to easily and reliably increase the uniformity of the degree of the hydrophobizing treatment of the particles or portions of the surfaces of the particles (including the inner surfaces of the pores). When the hydrophobizing treatment using a silane compound is performed in a liquid phase, a desired reaction is allowed to favorably progress to form a chemical adsorption film of the silane compound by immersing the particles to be subjected to the hydrophobizing treatment in a liquid containing the silane compound. Moreover, when the hydrophobizing treatment using a silane compound is performed in a gas phase, a desired reaction is allowed to favorably progress to form a chemical adsorption film of the silane compound by exposing the particles to be subjected to the hydrophobizing treatment to the vapor of the silane compound.

The average particle size of the particles constituting the powder is preferably 1 μm or more and 25 μm or less, and more preferably 1 μm or more and 15 μm or less, but is not particularly limited thereto. This allows the three-dimensional object to be particularly excellent in mechanical strength, and it is possible to more effectively prevent the unintentional generation of unevenness in the manufactured three-dimensional object, thus allowing the three-dimensional object to be particularly excellent in accuracy of the dimensions. Moreover, the powder and the powder-containing composition, which contains the powder, can be particularly excellent in fluidity, thus allowing the three-dimensional modeled object to be particularly excellent in productivity. It should be noted that in the invention, the average particle size refers to the volume-based average particle size. For example, the average particle size can be determined by measuring, using a Coulter-counter type particle size distribution measurement apparatus (Type TA-II available from Coulter Electronics Inc.) with a 50-μm aperture, a dispersion prepared by adding a sample to methanol and dispersing the sample with an ultrasonic dispersing apparatus for 3 minutes.

Dmax of the particles constituting the powder is preferably 3 μm or more and 40 μm or less, and more preferably 5 μm or more and 30 μm or less. This allows the three-dimensional object to be particularly excellent in mechanical strength, and it is possible to effectively prevent the unintentional generation of unevenness in the manufactured three-dimensional object, thus allowing the three-dimensional object to be particularly excellent in accuracy of the dimensions. Moreover, the powder and the powder-containing composition, which contains the powder, can be particularly excellent in fluidity, thus allowing the three-dimensional object to be particularly excellent in productivity. In addition, it is possible to more effectively prevent the diffusion of light due to the particles on the surface of the manufactured three-dimensional object.

When porous particles are used as the particles, the porosity of the porous particles is preferably 50% or more, and more preferably 55% or more and 90% or less. Accordingly, the porous particles have sufficient spaces (pores) where the curable resins enter, and the porous particles themselves can be excellent in mechanical strength. As a result, the three-dimensional object in which a binding resin enters the pores can be particularly excellent in mechanical strength. It should be noted that in the invention, the porosity of the particles refers to a ratio (volume fraction) of the volume of the pores existing inside the particles to the apparent volume of the particles. When the density of the particles is defined as ρ (g/cm³) and the true density of the components of the particles is defined as ρ0 (g/cm³), the porosity of the particles is a value represented by the expression {(ρ0−ρ)/ρ0}×100.

When porous particles are used as the particles, the average pore size (pore diameter) of the porous particles is preferably 10 nm or more, and more preferably 50 nm or more and 300 nm or less. This allows the three-dimensional object, which is a final product, to be particularly excellent in mechanical strength. Moreover, when colored ink containing a pigment is used in the manufacturing of the three-dimensional object, it is possible to favorably hold the pigment in the pores of the porous particles. Therefore, it is possible to prevent unintentional diffusion of the pigment, thus making it possible to reliably form a high-resolution image.

Although the particles constituting the powder may have any shape, it is preferable that the particles have a spherical shape. This allows the powder and the powder-containing composition, which contains the powder, to be particularly excellent in fluidity, thus allowing the three-dimensional object to be particularly excellent in productivity. Furthermore, it is possible to more effectively prevent the unintentional generation of unevenness in the manufactured three-dimensional object, thus allowing the three-dimensional object to be particularly excellent in accuracy of the dimensions. The powder may contain a plurality of types of particles that differ in the above conditions (e.g., components of the particles, types of the hydrophobizing treatment, and the like).

The voidage of the powder is preferably 70% or more and 98% or less, and more preferably 75% or more and 97.7% or less. This allows the three-dimensional modeled object to be particularly excellent in mechanical strength. Moreover, the powder and the powder-containing composition, which contains the powder, can be particularly excellent in fluidity, thus allowing the three-dimensional modeled object to be particularly excellent in productivity. Furthermore, it is possible to more effectively prevent the unintentional generation of unevenness in the manufactured three-dimensional modeled object, thus allowing the three-dimensional modeled object to be particularly excellent in accuracy of the dimensions. It should be noted that in the invention, voidage of the powder refers to, when a container with a predetermined volume (e.g., 100 mL) is filled with the powder, a ratio of the sum of the volume of the pores in all the particles constituting the powder and the volume of spaces existing between the particles to the volume of the container. When the bulk density of the powder is defined as P (g/cm³) and the true density of the components of the powder is defined as P0 (g/cm³), the voidage of the powder is a value represented by the expression {(P0−P)/P0}×100. The content of the powder in the powder-containing composition is preferably 10 mass % or more and 90 mass % or less, and more preferably 15 mass % or more and 58 mass % or less. This allows the powder-containing composition to be sufficiently excellent in fluidity, and the three-dimensional object, which is a final product, can be particularly excellent in mechanical strength.

Water-Soluble Resin

The powder-containing composition contains a water-soluble resin together with a plurality of particles. When the powder-containing composition contains the water-soluble resin, it is possible to bind (provisionally fix) the particles and effectively prevent the unintentional scattering of the particles, and the like. This makes it possible to increase the accuracy of the dimensions of the manufactured three-dimensional object. In the invention, it is sufficient that at least a portion of the water-soluble resin is soluble in water, but the solubility of the water-soluble resin in water (mass of the water-soluble resin capable of dissolving in 100 g of water) at 25° C. is preferably 5 (g/100 g water) or more, and more preferably 10 (g/100 g water) or more, for example.

Examples of the water-soluble resin include synthetic polymers such as polyvinylalcohol (PVA), polyvinylpyrrolidone (PVP), polysodium acrylate, polyacrylamide, modified polyamide, polyethyleneimine, and polyethylene oxide; natural polymers such as cornstarch, mannan, pectin, agar, alginic acid, dextran, glue, and gelatin; and semisynthetic polymers such as carboxymethylcellulose, hydroxyethylcellulose, oxidized starch, and modified starch. These compounds can be used alone or in combination of two or more.

Of these, if polyvinylalcohol is used as the water-soluble resin, the three-dimensional object can be particularly excellent in mechanical strength. Moreover, it is possible to more favorably control the properties (e.g., solubility in water and water resistance) of the water-soluble resin and the properties (e.g., viscosity, particle fixing force, and wettability) of the powder-containing composition by adjusting the degree of saponification and the degree of polymerization. Therefore, it is possible to more favorably manufacture various three-dimensional objects. Of the various water-soluble resins, polyvinylalcohol is inexpensive and is stably supplied. This makes it possible to suppress the production cost and to stably manufacture the three-dimensional object.

If the water-soluble resin contains polyvinylalcohol, the degree of saponification of the polyvinylalcohol is preferably 85 or more and 90 or less. This makes it possible to suppress the decrease in the solubility of polyvinylalcohol in water. Therefore, when the powder-containing composition contains water, it is possible to effectively suppress a decrease in adhesiveness between adjacent cross section bodies. If the water-soluble resin contains polyvinylalcohol, the degree of polymerization of the polyvinylalcohol is preferably 300 or more and 1000 or less. Accordingly, when the powder-containing composition contains water, the mechanical strength of the cross section bodies and the adhesiveness between the adjacent cross section bodies can be particularly excellent.

If polyvinylpyrrolidone (PVP) is used as the water-soluble resin, the following effects are obtained. That is, since polyvinylpyrrolidone is excellent in adhesiveness to various materials such as glass, metal, and plastics, a portion of the layer to which no ink is applied can be particularly excellent in strength and stability of the shape, thus allowing the three-dimensional object, which is a final product, to be particularly excellent in accuracy of the dimensions. Moreover, since polyvinylpyrrolidone is highly soluble in various organic solvents, if the powder-containing composition contains an organic solvent, the powder-containing composition can be particularly excellent in fluidity, and a powder composition layer in which the unintentional variation of thickness is effectively prevented can be favorably formed, thus allowing the three-dimensional object, which is a final product, to be particularly excellent in accuracy of the dimensions. In addition, since polyvinylpyrrolidone is also highly soluble in water, it is possible to easily and reliably remove particles that constitute the powder composition layers and do not bind to one another with the curable resins in a non-binding particle removing process after the modeling. Since polyvinylpyrrolidone has an appropriate affinity to the powder, entrance into the pores as described above is sufficiently unlikely to occur, whereas the wettability to the surfaces of the particles is relatively high. Accordingly, the above function of provisional fixing can be effectively exhibited. Since polyvinylpyrrolidone has excellent affinity to various coloring agents, if the object portion forming ink and the sacrificial layer forming ink containing a coloring agent are used in an ink applying process, it is possible to effectively prevent unintentional diffusion of the coloring agent. Since polyvinylpyrrolidone has a function of preventing electrification, if a powder composition that is not in paste form is used as the powder-containing composition in a powder composition layer forming process, it is possible to effectively prevent the scattering of the powder composition. If a powder composition that is in paste form is used as the powder-containing composition in the powder composition layer forming process, and the powder composition in paste form contains polyvinylpyrrolidone, it is possible to effectively prevent the inclusion of bubbles in the powder-containing composition, thus making it possible to effectively prevent the occurrence of defects due to the inclusion of bubbles during the powder composition layer forming process. If the water-soluble resin contains polyvinylpyrrolidone, the weight-average molecular weight of the polyvinylpyrrolidone is preferably 10000 or more and 1700000 or less, and more preferably 30000 or more and 1500000 or less. Accordingly, the above functions can be more effectively exhibited.

It is preferable that the water-soluble resin is in liquid form (e.g., soluble form and molten form) in the powder-containing composition in at least the powder composition layer forming process. This makes it possible to easily and reliably increase the uniformity of the thickness of the layers made of the powder-containing composition. The content of the water-soluble resin in the powder-containing composition is preferably 15 vol % or less, and more preferably 2 vol % or more and 5 vol % or less with respect to the bulk volume of the powder. This allows the water-soluble resin to sufficiently exhibit the above functions and makes it possible to ensure a wider space where the object portion forming ink and the sacrificial layer forming ink enter, thus allowing the three-dimensional object to be particularly excellent in mechanical strength.

Solvent

The powder-containing composition may contain a solvent in addition to the water-soluble resin and the powder as described above. This allows the powder-containing composition to be particularly excellent in fluidity, thus allowing the three-dimensional object to be particularly excellent in productivity. It is preferable that the water-soluble resin dissolves in the solvent. This allows the powder-containing composition to have favorable fluidity, thus making it possible to more effectively prevent the unintentional variation of the thickness of the powder composition layer made of the powder-containing composition. Moreover, when the powder composition layer from which the solvent is removed is formed, the water-soluble resin can adhere to the particles with higher uniformity over the entire powder composition layer, thus making it possible to more effectively prevent the occurrence of unintentional composition irregularities. Therefore, it is possible to more effectively prevent the unintentional variation of the mechanical strength in the portions of the three-dimensional object, which is a final product, thus making it possible to further increase the reliability of the three-dimensional object.

Examples of the solvent contained in the powder-containing composition include water; alcoholic solvents such as methanol, ethanol, and isopropanol; ketone-based solvents such as methyl ethyl ketone and acetone; glycol ether-based solvents such as ethylene glycol monoethyl ether and ethylene glycol monobutyl ether; glycol ether acetate-based solvents such as propylene glycol 1-monomethyl ether 2-acetate and propylene glycol 1-monoethyl ether 2-acetate; polyethylene glycol; and polypropylene glycol. These solvents can be used alone or in combination of two or more.

Of these, it is preferable that the powder-containing composition contains water. This makes it possible to more reliably dissolve the water-soluble resin, and therefore, the powder-containing composition can be particularly excellent in fluidity and the powder composition layer made of the powder-containing composition can be particularly excellent in uniformity of the composition. Moreover, it is easy to remove water after the powder composition layer is formed, and when water remains in the three-dimensional object, water is unlikely to adversely affect the three-dimensional object. In addition, water is advantageous from the viewpoint of safety to a human body and environmental problems.

When the powder-containing composition contains a solvent, the content of the solvent in the powder-containing composition is preferably 5 mass % or more and 75 mass % or less, and more preferably 35 mass % or more and 70 mass % or less. This allows the effect of the inclusion of the above solvent to be more prominently exhibited, and the solvent can be easily removed in a short period of time during the manufacturing of the three-dimensional object. Therefore, it is advantageous from the viewpoint of an increase in the productivity of the three-dimensional object. In particular, if the powder-containing composition contains water as the solvent, the content of the water in the powder-containing composition is preferably 20 mass % or more and 73 mass % or less, and more preferably 50 mass % or more and 70 mass % or less. This allows the above effects to be more prominently exhibited.

Other Components

The powder-containing composition may contain components other than the above components. Examples of such components include a polymerization initiator; a polymerization promoter; a permeation promoter; a wetting agent (humectant); a fixing agent; an antifungal agent; a preservative; an antioxidant; an ultraviolet absorber; a chelating agent; and a pH adjusting agent.

### D. Experimental Results

Next, experiments performed to confirm the preferable range of the curing ratio of the liquid subjected to the provisional curing and the results thereof will be described.

FIG. 4 is a diagram showing typical compositions of a powder composition (powder-containing composition) that can be used in the embodiment. The powder composition of type 1 contains X-37B (having an average particle size of 3.7 μm and a bulk specific gravity of 0.3 g/cm³) available from Tokuyama Corporation as porous silica. The powder composition of type 2 contains E-75 (having an average particle size of 2.4 μm and a bulk specific gravity of 0.26 g/cm³) available from Tosoh Silica Corporation as porous silica. PVA (model number: JP-05) available from Japan VAM & POVAL Co., Ltd. or PVP (model number: K-30) available from Nippon Shokubai Co., Ltd. can be used as a binder (water-soluble resin) in both type 1 and type 2, for example. Type 1 and type 2 both contain the porous silica in an amount of 35 parts by mass, the binder in an amount of 10 parts by mass, and water in an amount of 55 parts by mass.

If the modeling resolution in the X and Y directions is 720 dpi and the thickness (lamination pitch) of the cross section body is 50 μm, for example, it is preferable that the discharge amount per droplet of the liquid is as follows depending on the types of the porous silica in type 1 and type 2 in order to ensure the modeling accuracy of the three-dimensional object. It should be noted that the values in parentheses indicate a liquid filling ratio per unit volume (voxel) in accordance with the modeling resolutions.

Type 1

Favorable range: 34 ng (44.5%) to 42 ng (56.2%)

More preferable value: 38 ng (50.9%)

Type 2

Favorable range: 32 ng (42.9%) to 40 ng (53.6%)

More preferable value: 36 ng (48.2%)

In the experiments, the powder composition of type 1 was used as the powder composition, and the object portion forming ink having the following composition was used as the liquid.
2-(2-Vinyloxyethoxy)ethyl acrylate: 32 parts by mass
Polyether-based aliphatic urethane acrylate oligomer: 10 parts by mass
2-Hydroxy-3-phenoxypropyl acrylate: 13.75 parts by mass
Dipropylene glycol diacrylate: 15 parts by mass
4-Hydroxybutyl acrylate: 20 parts by mass
Bis(2,4,6-trimethylbenzoyl)-phenylphosphine oxide: 5 parts by mass
2,4,6-Trimethylbenzoyl-diphenyl-phosphine oxide: 4 parts by mass

In the experiments, the modeling resolution in the X and Y directions was 720 dpi, and the thickness (lamination pitch) of the cross section body was 50 μm. The discharge amount per droplet of the liquid was 38 ng, and the flight speed of the ink was 8 m/second. The provisional curing energy was applied at a specific time that was after the liquid was discharged from the head unit, before the liquid reached the bottom surface of the powder composition layer, and at which at least a portion of the liquid existed above the upper surface of the powder composition layer.

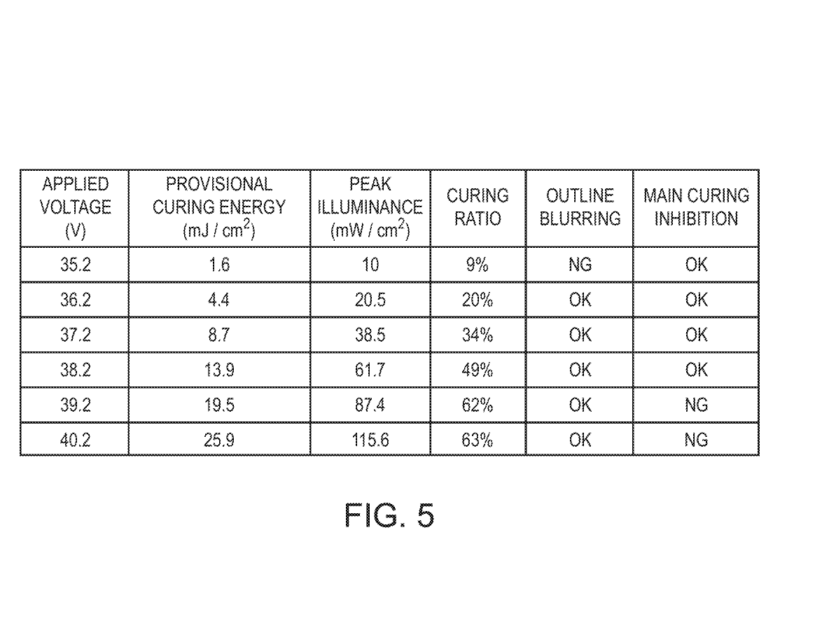

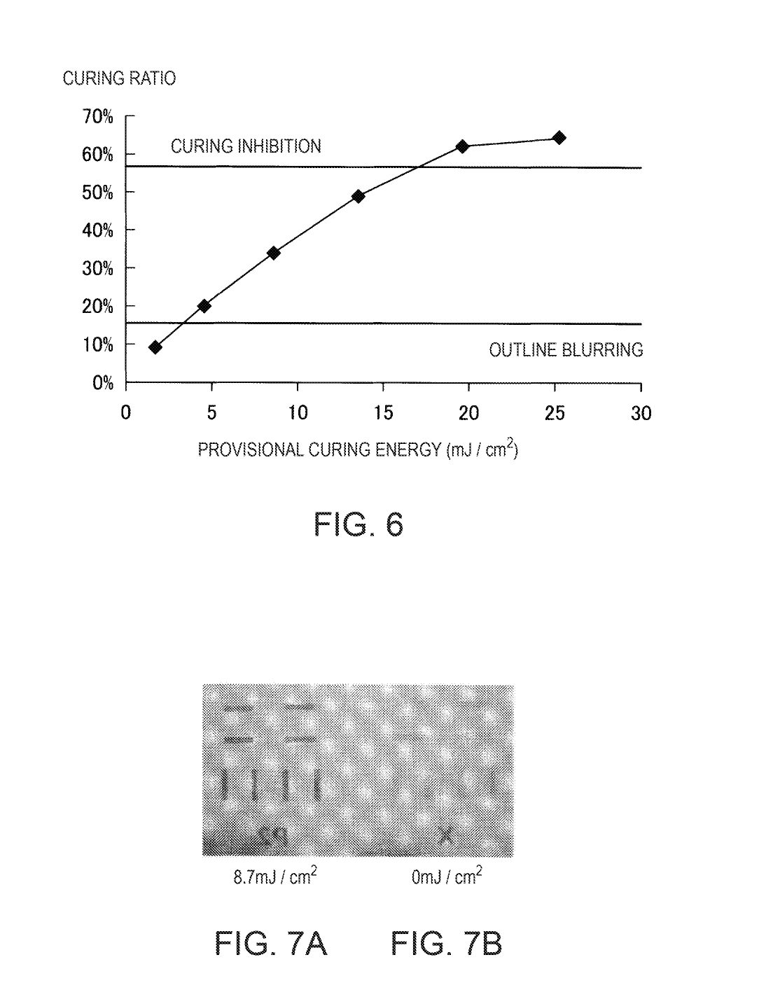

FIG. 5 is a diagram showing a list of experimental results. In the experiments, when the provisional curing was performed at the time described in the above embodiment, the provisional curing energy was variously changed, and the influence on the blurring of the outline of the object formed in the powder composition layer and on the main curing were evaluated. FIG. 5 shows the voltages applied to the provisional curing light emitting apparatus 62, the provisional curing energies output in accordance with the voltages, and the peak illuminances. Furthermore, FIG. 5 shows, in accordance with these conditions, the measurement results of the curing ratio of the liquid, and the experimental results indicating whether or not blurring of the outline occurred and whether or not the main curing was inhibited. FIG. 6 shows a relationship between the provisional curing energies and the curing ratios that was obtained as the result of the experiments.

In the experiments, the curing ratio was determined by measuring a peak wavelength near 810 cm⁻¹ using a Fourier transform infrared spectrophotometer (FT-IR) (Magna860 available from Nicolet) with a thunderdome attachment. More specifically, the peak intensity of the liquid to which no curing energy was applied was defined as 0% hardness, and a ratio of a decrease in the peak intensity was defined as the curing ratio. It should be noted that the peak intensity obtained when the elimination of a double bond saturated and reached a stationary state was defined as 100% hardness.

FIGS. 7A and 7B are diagrams showing a modeled pattern for determining whether or not the outline is blurred. In the experiments, modeled patterns shown in FIGS. 7A and 7B were formed in the powder composition layer in order to evaluate the blurring of the outline. These modeled patterns were configured by arranging a plurality of 1 mm×5 mm rectangular shapes. FIG. 7A shows a pattern formed in the powder composition layer when the provisional curing energy was 8.7 mJ/cm², and FIG. 7B shows a pattern formed in the powder composition layer when the provisional curing energy was 0 mJ/cm², that is, no provisional curing energy was applied thereto.

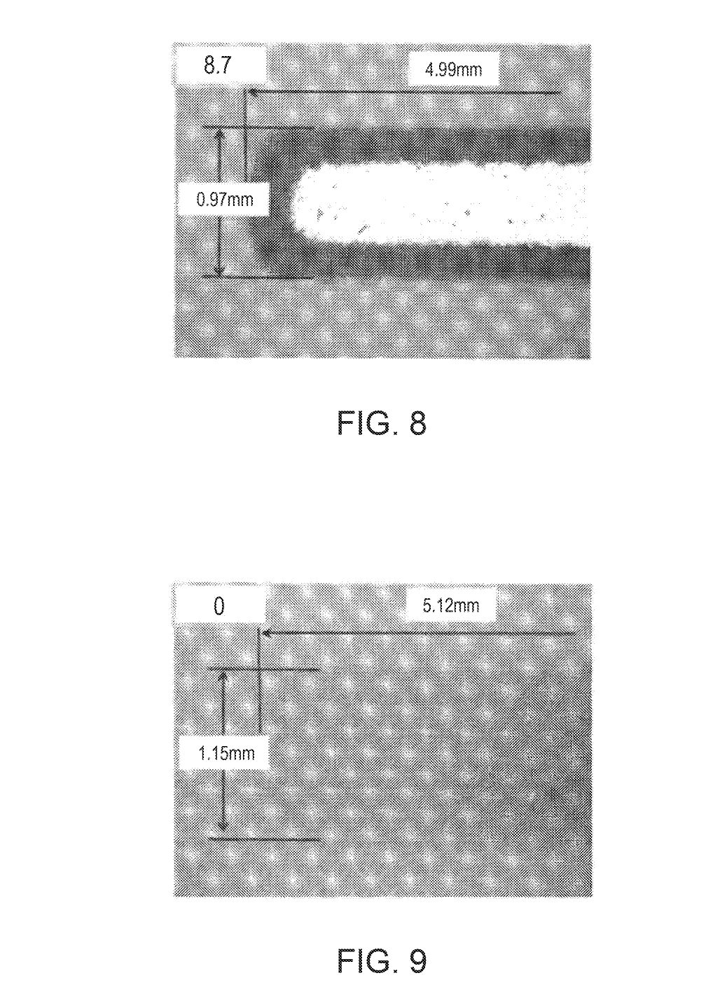

FIG. 8 is a partially enlarged view of FIG. 7A. FIG. 9 is a partially enlarged view of FIG. 7B. In the experiments, cases where all the lengths in the longitudinal direction of the rectangular shapes in the modeled pattern were within an error of plus or minus 1% of the intended value (5 mm) was evaluated as being acceptable (OK), and cases other than the acceptable cases were evaluated as not being acceptable (NG). According to this criterion, when the provisional curing energy was 8.7 mJ/cm², the dimensions in the longitudinal direction were within a range of plus or minus 1% as shown in FIG. 8 and thus were acceptable, but when the provisional curing energy was 0 mJ/cm², the dimensions in the longitudinal direction were out of the range of plus or minus 1% as shown in FIG. 9 and thus were evaluated as not being acceptable.

In the experiments, the inhibition of the main curing was evaluated as not being inhibited by the provisional curing (OK) in cases where all the curing ratios of the rectangular shapes in the modeled pattern were 95% or more after the main curing and no tackiness remained on the surface of the modeled pattern after the curing, and it was evaluated as being inhibited (NG) in cases where these conditions were not satisfied. It should be noted that the curing ratio is more preferably 98% or more after the main curing. In the experiments, energy of 170 mJ/cm² was applied as the main curing energy. It should be noted that the main curing energy is more preferably 200 mJ/cm² or more in consideration of margins.

According to the experimental results shown in FIGS. 5 and 6, when the curing ratio of the modeled object became 20% or more due to the provisional curing, the outline of the modeled object was not blurred. When the curing ratio of the modeled object exceeded 49% and became 62% or more due to the provisional curing, the curing ratio of the modeled object did not increase to a predetermined curing ratio (95%) even when the main curing was performed, or alternatively, the tackiness remained on the surface, and the result was that the main curing was inhibited by the provisional curing. Therefore, according to the experimental results, it was confirmed that it is preferable to apply the provisional curing energy such that the curing ratio of the liquid is 20% or more and 50% or less. The range of the provisional curing energy for the ink used in the experiments was about 5 to 15 mJ/cm². It should be noted that it is more preferable to apply the provisional curing energy such that the curing ratio of the liquid is 30% or more and 40% or less in consideration of margins from the viewpoint of both the blurring of the outline and the inhibition of the main curing.

The invention is not limited to the above-described embodiments, and can be achieved in various configurations without departing from the gist of the invention. For example, the technical features in the embodiments corresponding to the technical features in the aspects described in Summary can be replaced or combined as appropriate in order to solve some or all of the problems described above, or in order to achieve some or all of the aforementioned effects. Technical features that are not described as essential in the specification can be deleted as appropriate.

The entire disclosure of Japanese patent No. 2015-049146, filed Mar. 12, 2015 is expressly incorporated by reference herein.

What is claimed is:

1. A three-dimensional modeling apparatus for modeling a three-dimensional object, comprising:
a powder composition layer forming unit for forming a powder composition layer using a powder-containing composition that contains powder;
a head unit from which a curable liquid is discharged to a first surface of the powder composition layer; and
a curing energy applying unit for applying curing energy to the liquid at a time that is after the liquid is discharged from the head unit, before the liquid permeates the powder composition layer and reaches a second surface of the powder composition layer, and at which at least a portion of the liquid exists on the head unit side with respect to the first surface of the powder composition layer.

2. The three-dimensional modeling apparatus according to claim 1,
wherein the curing energy applying unit applies the curing energy such that a curing ratio of the liquid is 20% or more and 50% or less.

3. The three-dimensional modeling apparatus according to claim 1,
wherein after the liquid is discharged, the curing energy applying unit applies the curing energy such that a portion of the liquid that is located on the head unit side with respect to the first surface of the powder composition layer has a fluidity lower than that of a portion that is located on the second surface side with respect to the first surface of the powder composition layer.

4. The three-dimensional modeling apparatus according to claim 1,
wherein the curing energy applying unit starts to apply the curing energy before a diameter of the liquid discharged from the head unit along the first surface reaches a value obtained by adding a value of twice a thickness of the powder composition layer to a diameter of the liquid when the liquid lands on the powder composition layer.

5. The three-dimensional modeling apparatus according to claim 1,
wherein the curing energy applying unit starts to apply the curing energy between 30 milliseconds to 1 second after the liquid is discharged from the head unit.

6. The three-dimensional modeling apparatus according to claim 1,
wherein the powder-containing composition contains powder, a water-soluble resin, and a solvent.

7. A method for manufacturing a three-dimensional object using a three-dimensional modeling apparatus, the method comprising:
forming a powder composition layer using a powder-containing composition that contains powder;
discharging a curable liquid to a first surface of the powder composition layer; and
applying curing energy to the liquid at a time that is after the liquid is discharged, before the liquid permeates the powder composition layer and reaches a second surface of the powder composition layer, and at which at least a portion of the liquid exists on a head unit side with respect to the first surface of the powder composition layer.

8. The manufacturing method according to claim 7,
wherein the powder-containing composition contains powder, a water-soluble resin, and a solvent.

9. A computer program for controlling a three-dimensional modeling apparatus to manufacture a three-dimensional object, the computer program for causing a computer to implementing the functions of:
controlling the three-dimensional modeling apparatus to form a powder composition layer using a powder-containing composition that contains powder;
controlling the three-dimensional modeling apparatus to discharge a curable liquid to a first surface of the powder composition layer; and
controlling the three-dimensional modeling apparatus to apply curing energy to the liquid at a time that is after the liquid is discharged, before the liquid permeates the powder composition layer and reaches a second surface of the powder composition layer, and at which at least a portion of the liquid exists on a head unit side with respect to the first surface of the powder composition layer.
